(19) United States
(12) Patent Application Publication
(10) Pub. No.: US 2026/0362332 A1
(43) Pub. Date: Nov. 12, 2026

(54) METHOD AND APPARATUS FOR POWER SAVING IN MOBILE WIRELESS COMMUNICATION SYSTEM

(71) Applicant: SETLAB Co., LTD., Gyeonggi-do (KR)

(72) Inventor: Soenghun KIM, Gyeonggi-do (KR)

(21) Appl. No.: 19/660,277

(22) Filed: Apr. 28, 2026

(30) Foreign Application Priority Data
May 2, 2025 (KR) 10-2025-0057925
Apr. 2, 2026 (KR) 10-2026-0060079

(51) Int. Cl. H04W 52/02; H04W 68/02

(52) U.S. Cl. CPC H04W 52/0235; H04W 68/02

(57) ABSTRACT

A method for power-efficient paging in wireless communication is provided. A user equipment (UE) receives system information containing low power wake-up signal (LP-WUS) parameters, calculates paging occasion (PO) and a LP-WUS occasion index based on least significant bits (LSBs) of a 5G-S-TMSI and system parameters, and determines its subgroup identifier. While operating in a low power mode, the UE monitors the LO to detect specific codepoints determined based on n LSBs and m LSBs of the 5G-S-TMSI, a number of total paging frames, a total number of subgroups, and a number of paging occasions associated with LP-WUS occasions. In response to detecting a codepoint corresponding to its specific subgroup or all subgroups, the UE switches to main receiver mode and monitors a physical downlink control channel (PDCCH) for paging messages, achieving significant battery power savings.

### CROSS-REFERENCE TO RELATED APPLICATION

This application claims priority to and the benefit of Korean Patent Application Nos. 10-2025-0057925, filed on May 2, 2025, and 10-2026-0060079, filed on Apr. 2, 2026. Each of the above documents is incorporated herein by reference in its entirety.

### BACKGROUND

### Technical Field

The present disclosure relates to power saving for a terminal.

### Related Art

5G systems are designed and developed targeting for various vertical use cases. Key performance indicators for 5G systems are latency, reliability, data rate and UE energy efficiency. In general, 5G devices consume tens of milliwatts in RRC_INACTIVE/RRC_IDEL state and hundreds of milliwatts in RRC_CONNECTED state. By reducing energy consumption, better user experience is achievable as less battery rechanges are required.

The power consumption is heavily affected by the configured length of duty cycle, e.g., paging cycle. To meet the longer battery life requirements, eDRX cycle with large value is expected to be used, resulting in high latency, which is not suitable for such services with requirements of both long battery life and low latency. It is desirable to support ultra-low power mechanism that can support low latency.

Currently, UEs need to periodically wake up once per DRX cycle, which dominates the power consumption in periods with no signalling or data traffic. If UEs are able to wake up only when they are triggered, e.g., paging, power consumption could be significantly reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on.

In the present disclosure, method and apparatus for low power consumption with reasonable latency. It is achieved by interplaying main radio (MR) component and low power receiver (LPR) such that the main radio consumes power only when necessary.

### SUMMARY

A method for efficient paging reception using Low Power Wake-Up Signal (LP-WUS) in wireless communication systems is disclosed. The user equipment (UE) operates in three main steps to minimize power consumption while maintaining reliable paging reception.

In the first step, the UE receives system information broadcast by the base station, which contains essential LP-WUS configuration parameters including the total subgroup number for LP-WUS, the number of subgroups per paging occasion, and the number of paging occasions associated with a LP-WUS occasion. Using these parameters along with the least significant bits (LSBs) of its 5G-S-TMSI, the UE calculates two key indices: a first occasion index determining its paging occasion (PO) and a second occasion index determining its LP-WUS occasion (LO). Additionally, the UE determines its specific subgroup identifier for targeted wake-up signal detection.

In the second step, the UE operates in low power receiver mode and monitors the determined LP-WUS occasion to detect specific codepoints transmitted by the base station. The codepoints are calculated based on multiple parameters including n LSBs and m LSBs of the 5G-S-TMSI, the number of total paging frames, and subgroup-related parameters. The UE can detect either a first codepoint specific to its subgroup or a second codepoint applicable to all subgroups.

In the third step, upon successful codepoint detection, the UE transitions to main receiver mode and monitors the physical downlink control channel (PDCCH) in the associated paging occasion to receive paging messages, thereby achieving significant battery savings through selective wake-up operation.

### BRIEF DESCRIPTION OF THE DRAWINGS

FIG. 1 is a diagram illustrating the architecture of a 5G system and a NG-RAN.

FIG. 2 is a diagram illustrating a wireless protocol architecture in a 5G system.

FIG. 3 is a diagram illustrating state transitions.

FIG. 4 illustrates overall operation of the UE and network.

FIG. 5 PLMN selection/Cell Selection/Reselection.

FIG. 6 illustrates RRC connection release procedure.

FIG. 7 illustrates RRC connection resumption procedure.

FIG. 8 is a diagram illustrating SSB and PSS/SSS.

FIG. 9 is a diagram illustrating LP-SS and LP-WUS.

FIG. 10 illustrates random access procedure.

FIG. 11 illustrates operation of UE and base station with regards to LP-SS.

FIG. 12 illustrates operation of UE and base station for LP-WUS.

FIG. 13 is a diagram illustrating paging monitoring and DRX in RRC_IDLE and RRC_INACTIVE.

FIG. 14 is a diagram illustrating WUS burst and WUS Time Window.

FIG. 15 illustrates operation of UE and base station for switching between MR and LR.

FIG. 16 illustrates another operation of UE and base station for switching between MR and LR.

FIG. 17 illustrates operation of UE, base station and AMF for LP-WUS monitoring.

FIG. 18 is a diagram illustrating an example on association between PF and LO.

FIG. 19 is a diagram illustrating another example on association between PF and LO.

FIG. 20 illustrates another operation of UE, base station and AMF for LP-WUS monitoring.

FIG. 21 illustrates LO, LMO, PO and PMO.

FIG. 22 illustrates PF, RF and LMO.

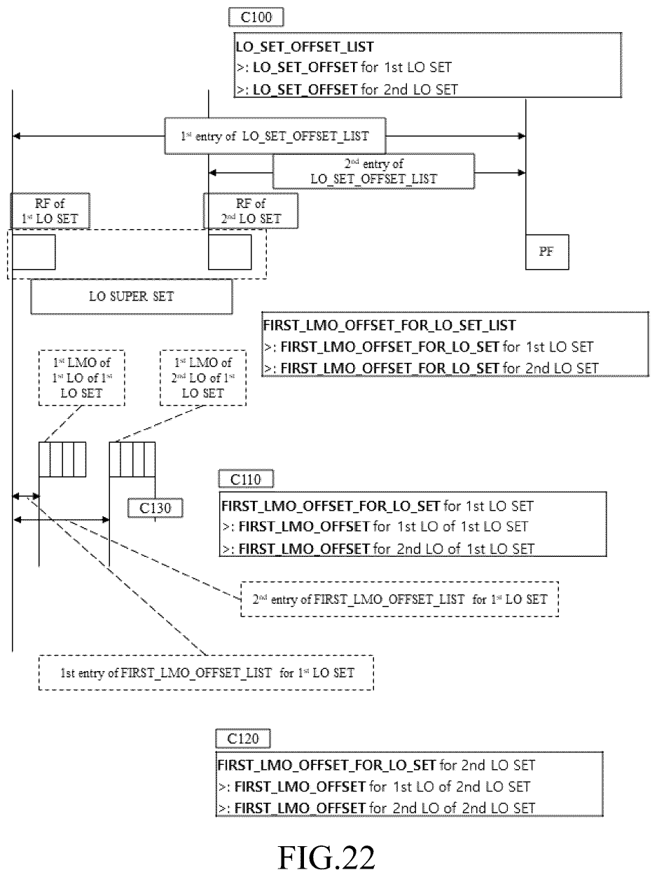

FIG. 23 illustrates examples of CP indexing.

FIG. 24 illustrates operations of UE, base station and AMF.

FIG. 25 illustrates an example of LMO beam and PMO beam mapping.

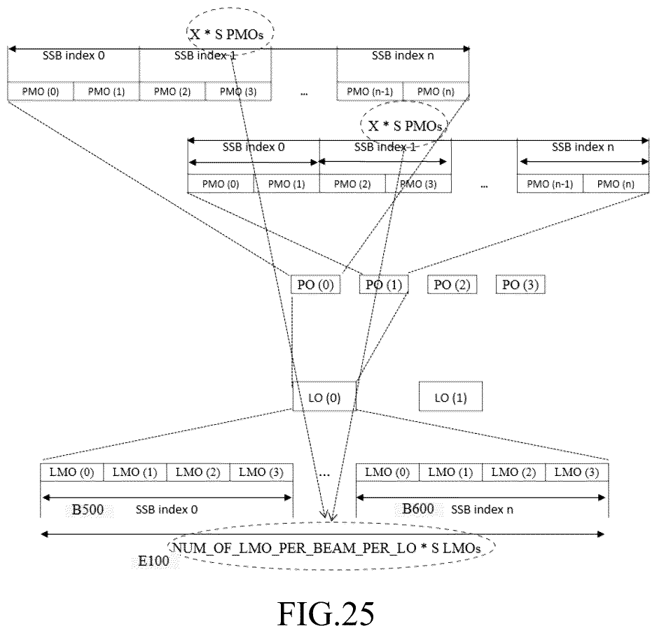

FIG. 26 is a block diagram illustrating operations of the terminal.

FIG. 27 is a block diagram illustrating a terminal.

FIG. 28 is a block diagram illustrating a base station.

FIG. 29 is a block diagram illustrating operations of the terminal.

FIG. 30 is a block diagram illustrating operations of the base station.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3cPP standards are used for convenience of explanation. However, the present disclosure is not limited by use of these terms and definitions and other arbitrary terms and definitions may be employed instead.

In the present disclosure, followings are used interchangeably:
>: MR and main receiver and main radio ;
>: LR and lower power receiver and lower power radio;
>: T_DRX_RAN and UE specific DRX value configured by RRC;
>: T_DRX_CN and UE specific DRX value configured by upper layers;
>: WUS occasion and WUS burst and LO;
>: LP-WUS and LMO;
>: sequence and bit string and code point (a sequence is a bit string which may represent a code point);
>: Network and base station, GNB, cell or core network entity (e.g. AMF);
>: LPSG and Low Power Sub Group;
>: Subgroup2Config and lpSubgroupConfig;
>: Subgroup2 and LPSG and lp_subgroup;
>: Subgroup2sNumPerPO and NUM_OF_LPSG_PER_PO;
>: Subgroup2sNumForUEID and NUM_OF_LPSG_FOR_UEID;
>: LpSubgroup_ID and lp_subgroup_id
>: LP-WUS-Config and
>: FIRST_LMO_OFFSET_FOR_LO_SET and
>: NUM_OF_LO_PER_LO_SET
>: Codepoint, code point and code-point and CP
>: LO-index and i-lo
>: PO-index and i_s
>: LMO-index and i-lmo
>: lp subgrouping and second subgrouping
>: <entry condition>and MR-to-LR switching condition set
>: <exit condition>and LR-to-MR switching condition set
>: T and DRX cycle
>: special CP-index and common CP-index;
>: UE-specific CP-index and dedicated CP-index;
>: “A monitors B” and “A receives and decodes/processes B”
>: Network and base station, GNB, cell or core network entity (e.g. AMF);
>: LPSG and Low Power Sub Group;

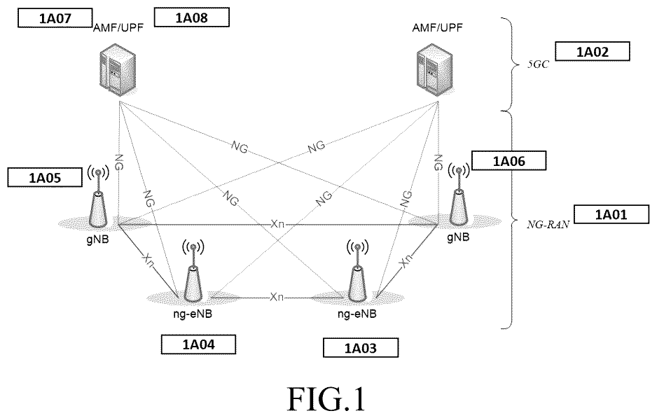

FIG. 1 is a diagram illustrating the architecture of a 5G system and a NG-RAN to which the disclosure may be applied. 5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below:

Functions for Radio Resource Management such as Radio Bearer Control, Radio Admission Control, Connection Mobility Control, Dynamic allocation of resources to UEs in uplink, downlink and sidelink (scheduling); IP and Ethernet header compression, uplink data decompression and encryption of user data stream; Selection of an AMF at UE attachment when no routing to an MME can be determined from the information provided by the UE; Routing of User Plane data towards UPF; Scheduling and transmission of paging messages; Scheduling and transmission of broadcast information (originated from the AMF or O&M); Measurement and measurement reporting configuration for mobility and scheduling; Session Management; QoS Flow management and mapping to data radio bearers; Support of UEs in RRC_INACTIVE state.

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

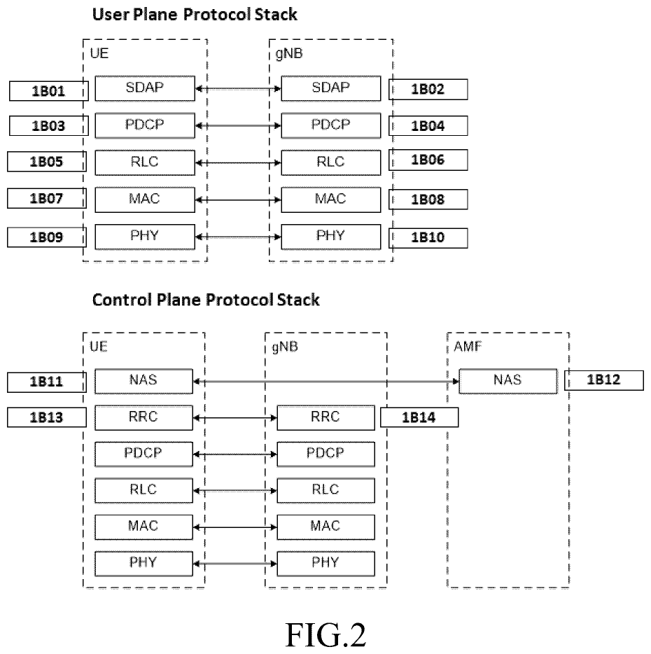

FIG. 2 is a diagram illustrating a wireless protocol architecture in a 5G system to which the disclosure may be applied.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

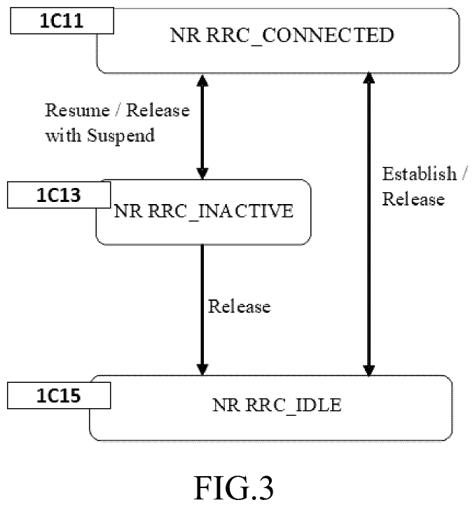

FIG. 3 is a diagram illustrating an RRC state transition.

Between RRC_CONNECTED 1C11 and RRC_INACTIVE 1C13, a state transition occurs by the exchange of the Resume message and the Release message containing the Suspend IE.

A state transition occurs between RRC_CONNECTED 1C11 and RRC_IDLE 1C15 through RRC connection establishment and RRC connection release.

The UE supports three RRC states.

In RRC_IDLE, UE has no RRC connection with RAN. The UE monitors paging channel and idle mode mobility (UE based mobility). As name implies, in RRC_IDLE state, data transmission/reception is not possible and power consumption is minimal. To perform data transfer, UE is required to transition to RRC_CONNECTED state.

In RRC_CONNECTED, UE has valid RRC connection with RAN. The UE establishes radio bearer configured for data transmission/reception. UE mobility is handled by network-controlled handover. RRC_CONNECTED state is most power-consuming state. To minimize power consumption during this state, C-DRX and other technique can be applied.

In RRC_INACTIVE, UE has suspended RRC connection with RAN. Before performing full scale data transfer, the UE and the base station resume the suspended RRC connection. UE mobility is handled by idle mode mobility within RAN defined area. If UE is capable of and configured by the base station, data transfer in limited scale can be performed in RRC_INACTIVE state, which is called small data transmission procedure.

RRC_IDLE state can be characterized with followings:
>1: PLMN selection; Broadcast of system information;
>1: Cell re-selection mobility;
>1: Paging for mobile terminated data is initiated by 5GC;
>1: DRX for CN paging configured by NAS.

RRC_INACTIVE state can be characterized with followings:
>1: PLMN selection; Broadcast of system information;
>1: Cell re-selection mobility;
>1: Paging is initiated by NG-RAN (RAN paging);
>1: RAN-based notification area (RNA) is managed by NG-RAN;
>1: DRX for RAN paging configured by NG-RAN;
>1: 5GC-NG-RAN connection (both C/U-planes) is established for UE;
>1: The UE AS context is stored in NG-RAN and the UE;
>1: NG-RAN knows the RNA which the UE belongs to.

RRC_CONNECTED state can be characterized with followings:
>1: 5GC-NG-RAN connection (both C/U-planes) is established for UE;
>1: The UE AS context is stored in NG-RAN and the UE;
>1: NG-RAN knows the cell which the UE belongs to;
>1: Transfer of unicast data to/from the UE;
>1: Network controlled mobility including measurements.

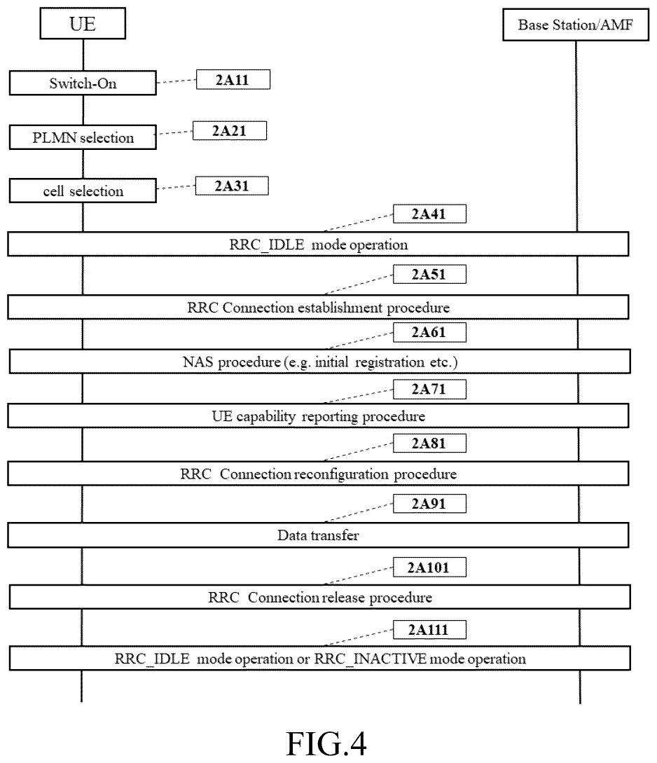

FIG. 4 illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is not longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

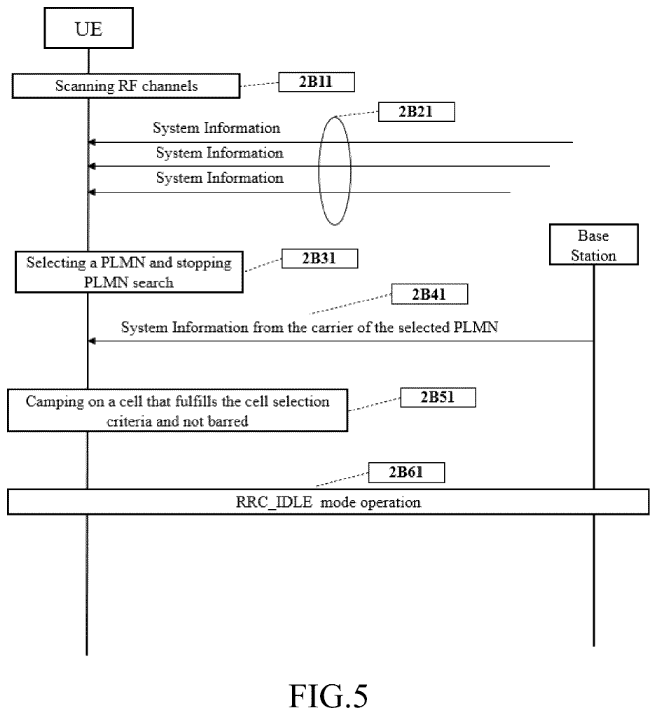

FIG. 5 illustrates the operation of the UE regarding PLMN selection and cell selection and cell reselection.

For PLMN selection, the UE may scan all RF channels to find available PLMNs 2B11. On each carrier, the UE shall search for the strongest cell and read its system information 2B21, in order to find out which PLMN(s) the cell belongs to. Each found PLMN is considered as a high quality PLMN (but without the RSRP value) provided that the measured RSRP value is greater than or equal to-110 dBm.

The search for PLMNs may be stopped when the PLMN to which the UE can register is found 2B31.

Once the UE has selected a PLMN, the cell selection procedure shall be performed in order to select a suitable cell of that PLMN to camp on.

The UE performs measurement on detectable cells and receives system information from whichever detectable cells that system information is readable 2B41.

The UE consider cell selection criterion S is fulfilled when:
Srxlev>0 AND
Squal>0
where, Srxlev is Cell selection RX level value (dB) and Squal is Cell selection quality value (dB). Srxlev is determined based on Measured cell RX level value (RSRP). Squal is determined based on Measured cell quality value (RSRQ).

The UE selects the cell that is part of the selected PLMN, and for which cell selection criteria are fulfilled, and of which cell access is not barred 2B51.

The UE camps on the selected cell. The UE perform RRC_IDLE mode operation 2B61 such as monitoring control channels to receive system information and paging and notification message.

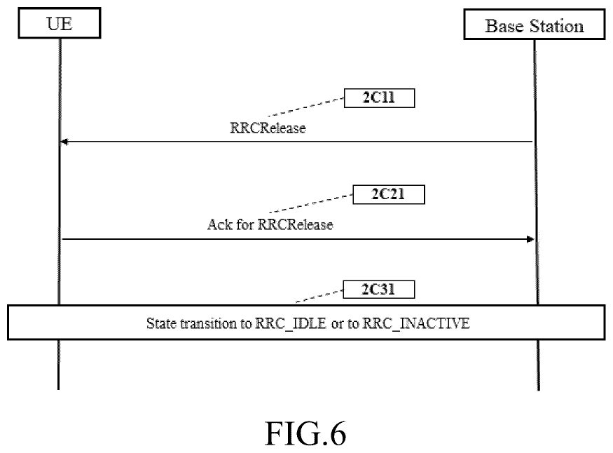

FIG. 6 illustrates RRC connection release procedure.

RRC connection release procedure comprises:
>1: transmission of RRCRelease from the base station to the UE 2C11; and
>1: transmission of acknowledgement for the RRCRelease from the UE to the base station 2C21; and
>1: state transition from RRC_CONNECTED to either RRC_IDLE or RRC_INACTIVE 2C31.

The purpose of RRC connection release procedure is either to release RRC connection (state transition to RRC_IDLE) or to suspend RRC connection (state transition to RRC_INACTIVE).

RRC connection release procedure may perform, in addition to state transition, various roles e.g., providing redirection information or providing cell reselection priorities.

The RRCRelease may comprise following fields for redirection:
>1: redirectedCarrierInfo field comprises RedirectedCarrierInfo IE;
>>2: RedirectedCarrierInfo IE comprises either CarrierInfoNR IE or RedirectedCarrierInfo-EUTRA IE;
>>>3: CarrierInfoNR IE comprises ARFCN-ValueNR IE and SubcarrierSpacing IE;

The UE may perform cell selection on the carrier indicated by CarrierInfoNR IE or RedirectedCarrierInfo-EUTRA IE.

The RRCRelease may comprise following fields to configure cell reselection priority:
>1: cellReselectionPriorities field comprises CellReselectionPriorities IE;
>>2: CellReselectionPriorities IE comprises:
>>>3: FreqPriorityListNR IE;
>>>3: t320 field indicates a timer value for cell reselection priority validity;

During idle mode mobility, the UE applies the CellReselectionPriorities until T320 expires or stops.

The RRCRelease may comprise following fields/IEs to transition UE to RRC_INACTIVE state:
>1: suspendConfig field comprises SuspendConfig IE;
>>2: fullI-RNTI field comprises I-RNTI-Value IE;
>>2: shortI-RNTI field comprises ShortI-RNTI-Value IE;
>>2: ran-PagingCycle field comprises PagingCycle IE;
>>2: ran-NotificationAreaInfofield comprises RAN-NotificationAreaInfo IE;
>>2: t380 field comprises PeriodicRNAU-TimerValue;
>>2: nextHopChainingCount field comprises NextHopChainingCount IE.
>>2: ran-ExtendedPagingCycle field comprises ExtendedPagingCycle IE.

To transit the UE to RRC_INACTIVE, the base station includes SuspendConfig IE in the RRCRelease. To transit the UE to RRC_IDLE, the base station does not include SuspendConfig IE in the RRCRelease.

Upon reception of RRCRelease, UE may:
>1: delay the actions caused by RRCRelease 60 ms from the moment the RRCRelease message was received or optionally when lower layers indicate that the receipt of the RRCRelease message has been successfully acknowledged, whichever is earlier;
>1: store the cell reselection priority information provided by the cellReselectionPriorities and start T320;
>1: if the RRCRelease includes suspendConfig:
>>2: reset MAC and release the default MAC Cell Group configuration;
>>2: apply the received suspendConfig except the received nextHopChainingCount;
>>2: if the sdt-Config is configured:
>>>3: for each of the DRB in the sdt-DRB-List, consider the DRB to be configured for SDT;
>>>3: if sdt-SRB2-Indication is configured, consider the SRB2 to be configured for SDT;
>>>3: re-establish the RLC entity for each RLC bearer that is not suspended;
>>>3: trigger the PDCP entity to perform SDU discard for SRB1 and SRB2;
>>>3: if sdt-MAC-PHY-CG-Config is configured, configure the PCell with the configured grant resources for SDT and start the cg-SDT-TimeAlignmentTimer;
>>3: if srs-PosRRC-Inactive is configured, apply the configuration and instruct MAC to start the inactivePosSRS-TimeAlignmentTimer;
>>2: re-establish RLC entities for SRB1;
>>2: stop the timer T319 if running;
>>2: store in the UE Inactive AS Context the nextHopChainingCount received in the RRCRelease message, the current K_{gNB} and K_{RRCint} keys, the ROHC state, the EHC context(s), the UDC state, the stored QoS flow to DRB mapping rules, the application layer measurement configuration, the C-RNTI used in the source PCell, the cellIdentity and the physical cell identity of the source PCell, the spCellConfigCommon within ReconfigurationWithSync of the NR PSCell (if configured) and all other parameters configured except for:
>>>3: parameters within ReconfigurationWithSync of the PCell;
>>>3: parameters within ReconfigurationWithSync of the NR PSCell, if configured;
>>>3: parameters within MobilityControlInfoSCG of the E-UTRA PSCell, if configured;
>>>3: servingCellConfigCommonSIB;
>>2: suspend all SRB(s) and DRB(s) and multicast MRB(s), except SRB0 and broadcast MRBs;
>>2: indicate PDCP suspend to lower layers of all DRBs and multicast MRBs;
>>2: start timer T380, with the timer value set to t380;
>>2: indicate the suspension of the RRC connection to upper layers;
>>2: enter RRC_INACTIVE and perform cell selection;
>1: else (if the RRCRelease does not include suspendConfig):
>>2: perform the actions upon going to RRC_IDLE;

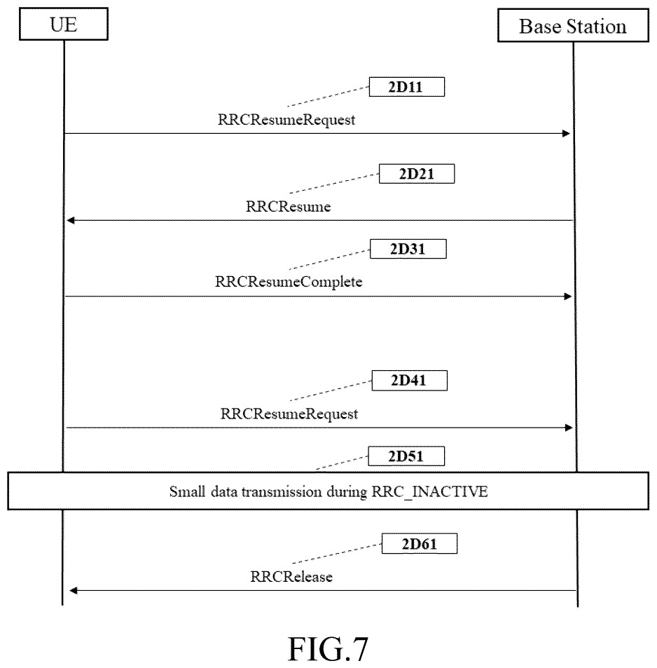

FIG. 7 illustrates RRC connection resumption procedure.

RRC connection resume procedure, in case of state transition from RRC_INACTIVE to RRC_CONNECTED, consists of RRC message exchange between the UE and the base station: RRCResumeRequest 2D11 and RRCResume 2D21 and RRCResumeComplete 2D31.

RRC connection resume procedure, in case of small data transmission without state transition, consists of RRC message exchange between the UE and thee base station: RRCResumeRequest 2D41 and RRCRelease 2D51.

RRC connection resume procedure is triggered by the UE due to various reasons. For example, RRC connection resume procedure for state transition is triggered periodically (upon T380 expiry) or event-driven (upon cell change to different RAN area) or data driven (upon uplink or downlink data arrival). RRC connection resume procedure for small data transmission is triggered only if channel condition is above specific threshold and the amount of data is expected to be relatively small.

Upon initiation of RRC connection resume procedure, the UE performs some preliminary operation such as starting timers such as T319 (for supervising the procedure) and timeAlignmentTimer (for uplink timing alignment) and applying common channel configuration (for transmission of RRCResumeRequest). Then UE transmits RRCResumeRequest 2D11 or 2D41 to the base station. The message comprises the UE identifier which can be used by the base station to identify the UE context where RRC connection information of the UE is stored.

When the base station determines that UE needs to be in RRC_CONNECTED state, the base station transmits RRCResume. Upon reception of RRCResume 2D21, the UE restores whole UE context based on the stored context at the time of RRCRelease reception and the received information in the RRCResume.

If the RRC connection resume procedure is triggered for small data transmission, the UE and the base station may perform data transfer during RRC connection resume procedure 2D51. When the base station determines that small data transmission is finished, the base station transmits RRCRelease 2D61.

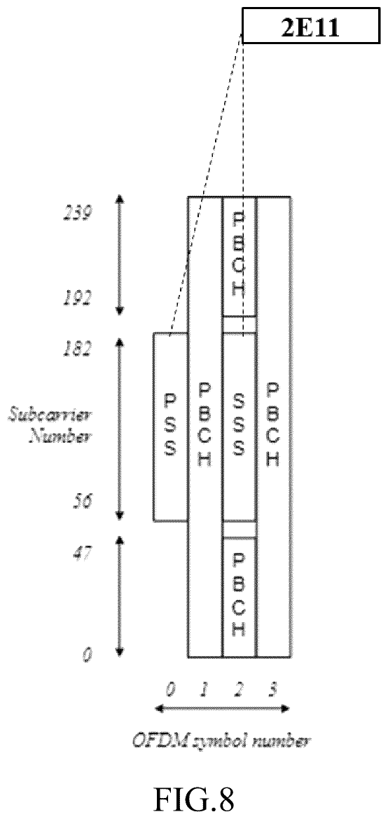

FIG. 8 is a diagram illustrating SSB and PSS/SSS.

The Synchronization Signal and PBCH block (SSB) consists of primary and secondary synchronization signals (PSS, SSS) 2E11, each occupying 1 symbol and 127 subcarriers, and PBCH spanning across 3 OFDM symbols and 240 subcarriers, but on one symbol leaving an unused part in the middle for SSS. For the 3 MHz channel bandwidth, the PBCH is further equally punctured from both edges to span 144 subcarriers. The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The PCIs of SSBs transmitted in different frequency locations do not have to be unique, i.e. different SSBs in the frequency domain can have different PCIs. However, when an SSB is associated with an RMSI, the SSB is referred to as a Cell-Defining SSB (CD-SSB). A PCell is always associated to a CD-SSB located on the synchronization raster.

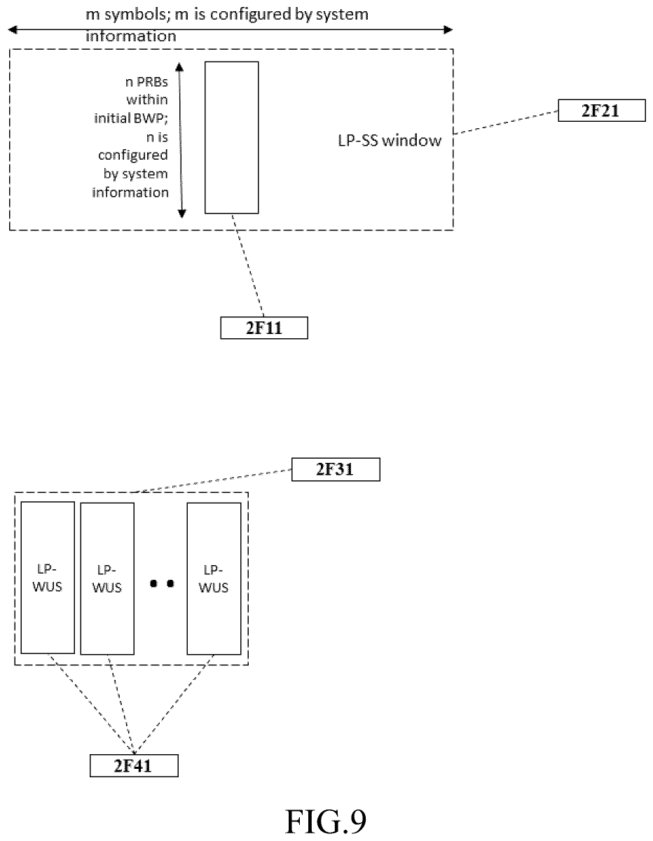

FIG. 9 is a diagram illustrating LP-SS and LP-WUS.

Low Power-Synchronization signal 2F11 is transmitted during a LP-SS window 2F21. LP-SS window occurs periodically. The length and the periodicity and starting time position of LP-SS window are configured by system information. The number of PRBs of LP-SS is configured by a first parameter in SIB1. The possible time locations of LP-SS (e.g. LP-SS window) is configured by a second parameter in SIB1. Alternatively, A third parameter can jointly configure time location and frequency location together.

A LP-WUS burst 2F31 consists of plurality of LP-WUSs 2F41. Each LP-WUS carries information about wake-up. The information about wake-up could be a specific sequence that is associated with one or more UE sub-groups. Frequency location/resource of LP-WUS is indicated by system information. The number of LP-WUSs per LP-WUS burst is also indicated by system information.

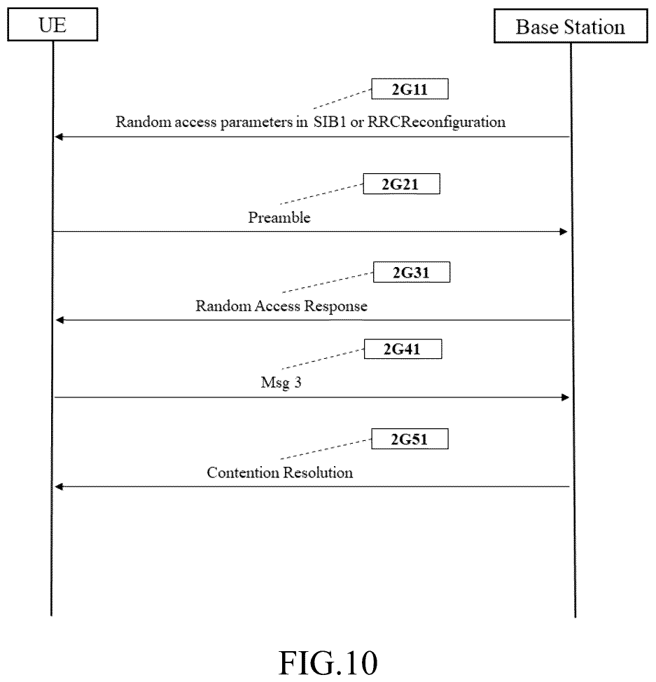

FIG. 10 illustrates random access procedure.

Random access procedure enables the UE to align uplink transmission timing, and indicate the best downlink beam, and transmit a MAC PDU that may contain CCCH SDU (e.g. RRCSetupRequest).

Random access procedure comprises preamble transmission 2G21, random access response reception 2G31, Msg 3 transmission 2G41 and contention resolution 2G51.

Parameters for random access procedure are provided in SIB1 (in case of initial access) or in RRCReconfiguration (in case of handover) 2G11.

Random access procedure may be triggered by a number of events such as initial access from RRC_IDLE (e.g. RRC connection establishment procedure), DL or UL data arrival, request by RRC upon synchronous reconfiguration (e.g. handover) and RRC Connection Resume procedure from RRC_INACTIVE etc.

When the random access procedure is initiated, the UE may perform following actions in order:
>1: flush the buffer for Msg 3;
>1: initialize the counters for preamble transmission and power ramping;
>1: select the uplink carrier for performing the random access procedure based on a rsrp threshold (e.g. rsrp-ThresholdSSB-SUL);
>1: select the set of Random Access resources applicable to the current Random Access procedure;
>1: select a SSB based on a rsrp threshold (e.g. rsrp-ThresholdSSB); a SSB corresponds to a downlink beam;
>1: select a random access preamble group based on the pathloss of the selected SSB and the potential Msg3 size and various parameters (e.g. ra-Msg3SizeGroupA, preambleReceivedTargetPower, msg3-DeltaPreamble, messagePowerOffsetGroupB etc); Preamble group selection enables the UE to request bigger uplink grant for Msg 3 transmission if channel condition is good enough and the potential Msg 3 size is above a certain threshold;
>1: select a random access preamble randomly with equal probability from the random access preambles associated with the selected SSB and the selected random access preamble group;
>1: determine the next available PRACH occasion from the PRACH occasions corresponding to the selected SSB;
>1: determine the transmission power of the preamble;
>>2: preamble transmission power=pathloss+preambleReceivedTargetPower+DELTA_PREAMBLE +(PREAMBLE_POWER_RAMPING_COUNTER−1)×PREAMBLE_POWER_RAMPING_STEP+POWER_OFFSET_2STEP_RA
>1: transmit the preamble in the determined PRACH occasion with the determined transmission power;
>1; start ra-ResponseWindow;
>1: monitor the PDCCH of the SpCell for Random Access Response(s) identified by the RA-RNTI while the ra-ResponseWindow is running;
>1: receive Random Access Response contains a MAC subPDU with Random Access Preamble identifier corresponding to the transmitted preamble;
>1: process the received Timing Advanced Command and the received UL grant;
>1: transmit a Msg 3 based on the received UL grant;
>>2: Msg 3 may contain e.g. CCCH SDU such as RRCSetupRequest or RRCResumeRequest;
>1: start ra-ContentionResolutionTimer;
>1: monitor the PDCCH while the ra-ContentionResolutionTimer is running;
>1: consider Contention Resolution successful when MAC PDU containing a UE Contention Resolution Identity MAC CE is received;
>1: consider the Random Access procedure successfully completed.

To receive downlink signal properly, downlink synchronization is required. For MR, UE establishes downlink synchronization based on PSS and SSS embedded in SSB. For LR, since MR and LR are separate components and process different downlink signals, separate synchronization is required. Downlink synchronization for LR is established based on LP-SS. For downlink synchronization for MR, UE may blindly search SSBs without assistance information provided in advance. Blind synchronization is not efficient way in a sense that it takes latency and UE battery consumption. Instead of blind synchronization, downlink synchronization for LP-SS is performed based on system information assisted way.

UE identifies from system information rough time window during when LP-SSs are transmitted. UE performs quick synchronization for LP-SS based on the rough time window.

For power saving purpose, followings are important:
minimizing the duration when the MR is active; and
minimizing the transition between MR and LR.

In the present invention:
the duration when the MR is active (or on) and LR is inactive (or off) is denoted as a first-time-duration; and
the duration when the LR is active (or on) and MR is inactive (or off) is denoted as a second-time-duration.

The first-time-duration and the second-time-duration alternate. During the first-time-duration, MR is used to periodically receive/measure SSB bursts. During the second-time-duration, LR is used to periodically receive/measure LP-SS. During the first-time-duration, MR is kept to active/on state and LR is kept to off state. During the second-time-duration, MR is in deep sleep and LR is on. During the first-time-duration, UE receives/measures SSB burst based on SSB-MTC and ssb-PositionsInBurst. During the second-time-duration, UE receives/measures LP-SS based on LP_SS_Timing_Configuration. LP-SS is processed based on a code sequence corresponding to short PCI and PSS/SSS is processed based on a code sequence corresponding to PCI.

The parameters that indicate the frequency resource on which the LP-SS is transmitted are transmitted via system information.

The waveform of LP-SS is on/off keying (OOK) and the waveform of SSB is orthogonal frequency division multiplexing (OFDM).

The UE determines the SS-RSRP and SS-RSRQ of n SSBs at a predetermined interval and selects one of them. The UE determines the RSRP of a single LP-SS every other predetermined interval. The LP-SS does not have a beam, and the SSB has a beam.

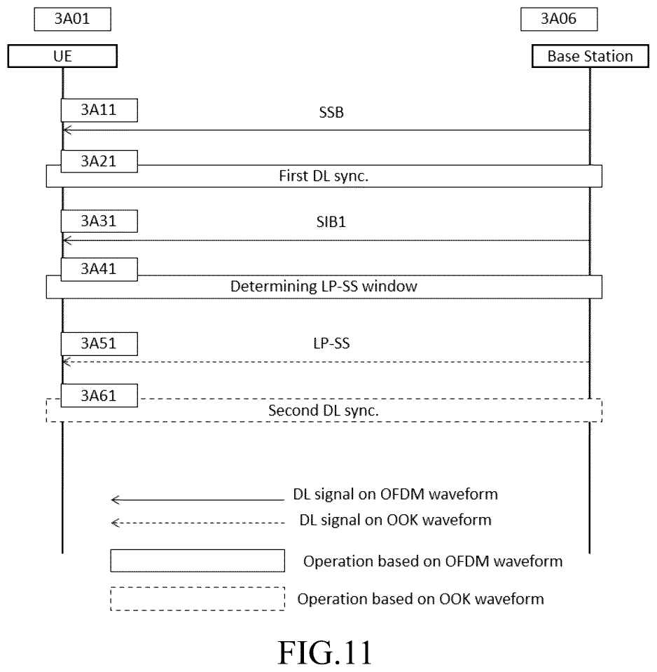

FIG. 11 illustrates operation of UE and base station for LP-SS.

UE 3A01 camp on a first cell. UE receive from a base station 3A06 one or more SSBs in the first cell 3A11. A SSB comprises PSS/SSS/PBCH.

UE establishes first downlink time synchronization (for Main Receiver) based on PSS/SSS in the SSB 3A21. UE determines frame boundary and symbol boundary based on the received PSS/SSS. UE determines PCI based on the sequence within PSS and SSS.

UE determines SFN of each frame from PBCH DM-RS and MIB. PBCH comprise MIB and PBCH DM-RS.

UE receives SIB1 Based on MIB 3A31.

UE determines the lower power sync signal window based on a first information (e.g. LP_SS_Timing_Configuration) 3A41. Based on the first information, UE determines SFN and frame boundary and symbol boundary and a length of LP-SS window.

The first information comprises a first integer (indicating the frame number for LP-SS window start) and a second integer (indicating the symbol number for LP-SS window start) and a third value representing a periodicity. The first frame of the LP-SS window starts at the radio frame where [the corresponding SFN mod first integer=0] is satisfied. The first symbol of the LP-SS window starts at the symbol of which symbol number is equal to second integer. LP-SS window has fixed size of 0.5. LP-SS window occurs every periodicity.

Alternatively, a first parameter indicating both periodicity and offset and a second parameter indicating the duration is provided in LP_SS_Timing_Configuration.

The parameters indicating the starting point of LP-SS window indicates a specific time point defined based on OFDM waveform, while downlink signal associated with the LP-SS window is processed based on OOK waveform.

UE determines the frequency resource of LP-SS based on a second information. The first information and the second information are comprised in SIB1 to facilitate quick synchronization. The second information comprises an integer indicating one or more PRBs of the initial BWP. Alternatively, LP-SS window and LP-SS frequency resource are defined with an index representing specific time/frequency resource (e.g. searchSpaceId). For example, in case that LP_SS_Timing_Configuration comprises a searchSpaceId x, LP-SS is transmitted in the time/frequency region that are defined by the corresponding SearchSpace and associated CORESET.

UE determine the code resource of LP-SS (or sequence applied to LP-SS) based on the PSS sequence and SSS sequence. PCI is determined from the PSS sequence and the SSS sequence. LP-SS sequence is determined from a short PCI (y LSBs of PCI or PCI mod x). 2\hat{ }y sequences or x sequences are predefined. Each of the predefined sequences corresponds to a short PCI.

UE performs measurement on SSB. When a set of conditions are fulfilled, UE starts LR (Low Power Receiver) to receive LP-SS in a LP-SS window 3A51.

UE receives LP-SS based on the LP-SS window and LP-SS frequency resource and LP-SS code resource.

UE establishes second downlink time synchronization (for Low Receiver) based on the received LP-SS 3A-61. UE considers LP-SS occurs every periodicity. UE performs RSRP measurement on the LP-SS. UE monitors wake up signal using the LR when the RSRP of LP-SS is greater than a predefined threshold.

There are 1008 unique physical-layer cell identities which is given by:
N_cell_ID=3* N_(1)_ID+N_(2)_ID,
where:
N_(1)_ID is derived from Secondary Synchronization Signal (SSS) and its range is from {0, 1 . . . 335}; and
N_(2)_ID is derived Primary Synchronization Signal (PSS) and its range is from {0, 1, 2}.

There are 33 short PCIs which is given by modulo operation of PCI or by taking predefined number of LSBs of PCI. UE determines PCI by determining which PSS sequence and SSS sequence are used in the PSS/SSS. UE tests multiple sequences for PSS and multiple sequences for SSS in detecting/acquiring PSS/SSS (or establishing first downlink time sync). UE tests only one sequence for LP-SS in detecting/acquiring LP-SS (establishing second time sync). UE determines the rough time duration/window for LP-SS based on the information in SIB1. UE determines exact timing for LP-SS by searching LP-SS during the rough time duration/window. Once the exact timing for LP-SS is determined, UE determines timings for subsequent LP-SSs based on the periodicity.

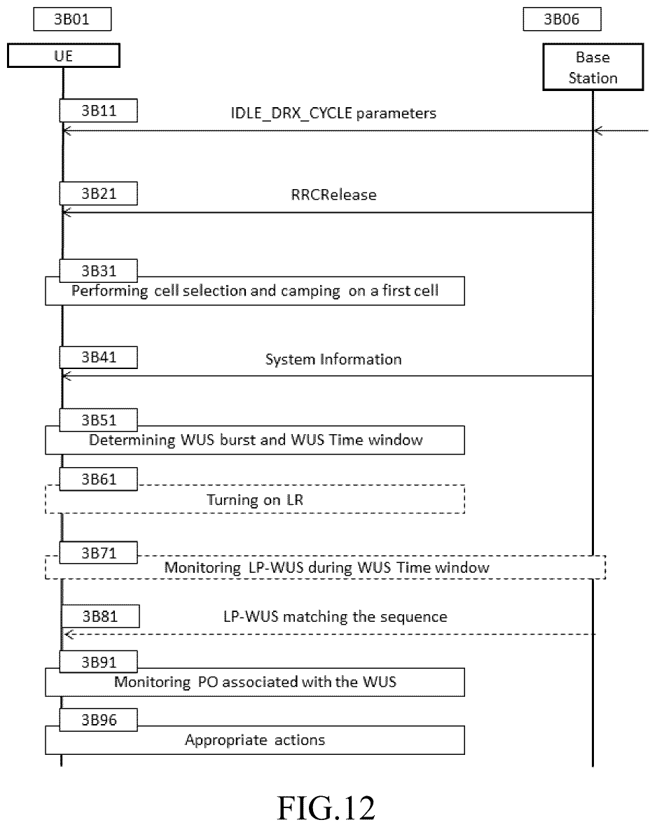

FIG. 12 illustrates operation of UE and base station for LP-WUS.

The LP-SS does not provide a separate frame number, which causes that UE is not able to determine the exact time point of WUS based on LP-SS timing. UE determines the exact time point of WUS based on paging frame (PF) and paging occasion (PO) and a configured offset.

After determining the PF and PO, the device determines that the first PO (or PF) corresponding to SSB0 and that the n WUS occasions from the first WUS occasion at an offset distance are the WUS occasions to be monitored.

WUS can indicate a single sequence. The terminal monitors the sequences corresponding to its sub-group and the special sequences. If either of them is detected, it will transition to MR-based behavior.

The following information is provided as system information.
>1: sub-group information;
>1: mapping relationships between sub-groups and sequences;
>1: the minimum time interval (offset_WUS_burst or minimum_offset) between the first PO and the first WUS occasion (or first WUS burst);
>1: the number of WUS occasions included in a WUS burst;
>1: Frequency range of LP-WUS (in the absence of this information, use the same frequency range as LP-SS).

UE wakes up if at least one WUS of WUS burst instruct wake-up. Alternatively, UE wakes up if all WUSs instructs wake-up.

UE monitors WUS burst every paging cycle if UE identifies WUS burst. If eDRX and PTW are configured, the UE configures the WUS PTW and monitor the WUS only within the configured WUS PTW. WUS PTW is the time interval that precedes PTW by offset.

UE performs followings.

UE switches on MR. UE performs PLMN selection. Upon PLMN is selected, UE performs NAS procedure such as ATTACH/REGISTRATION to register to the PLMN.

UE acquires IDLE_DRX_CYCLE parameters (T_DRX_CN and T_E_DRX_CN) during the NAS procedure 3B11. IDLE_DRX_CYCLE parameters are comprised in a NAS message sent from a LMF to the UE. T_DRX_CN is UE specific DRX configured by upper layer.

After completion of the NAS procedure, the base station may decide to put the UE to RRC_INACTIVE state.

UE receives from the base station a RRCRelease message for state transition 3B21.

UE performs state transition to RRC_INACTIVE based on reception of RRCRelease. UE acquires INACTIVE_DRX_CYCLE parameters (T_DRX_RAN and T_E_DRX_RAN) comprised in the RRCRelease. T_DRX_RAN is UE specific DRX configured by RRC.

UE performs cell selection and camps on a first cell 3B31. UE receives system information 3B41.

UE acquires followings from the system information:
>1: HFN and SFN;
>1: parameters for PF/PO determination;
>1: parameters for PTW determination; and
>1: parameters for LP-WUS.

UE determines 3B51:
>1: the PF/PO based on the parameters for PF/PO determination;
>1: the subgroup for LP-WUS based on the parameters for LP-WUS;
>1: WUS burst associated with the PO based on minimum_offset and other parameters;
>1: the WUS Time window based on the actual_offset (derived from the minimum_offset and the beginning time point of the WUS burst) and the PTW; and
>1: the frequency resource for LP-WUS.

The subsequent WUS burst occurs with a determined T (T is determined based on default DRX cycle and T_DRX_CN and T_E_DRX_CN and T_DRX_RAN and T_E_DRX_RAN).

UE turns on the LR and puts MR in the power saving mode (e.g. deep sleep mode or turning off) 3B61.

UE monitors, during the WUS Timing Window, LP-WUSs of the WUS burst for a configurable subgroup-specific-sequence and one or more predefined all-subgroup-sequences 3B71.

UE turns off the LP-WUR and turns on MR when either sequence is detected in at least one LP-WUS of one or more LP-WUSs of the WUS burst 3B81.

UE monitors the PO associated with the WUS burst 3B91.

UE takes appropriate actions based on the Short Message and Paging message received based on PDCCH of the PO 3B96.

The system information comprises:
>1: PCCH-Config;
>1: WUS-Config:
>>2: frequency resource parameters (at least followings):
>>>3: ARFCN IE indicating reference frequency (e.g. center frequency or lowest frequency) for the WUS frequency resource;
>>>3: bandwidth IE indicating the bandwidth of WUS frequency resource;
>>>3: PRBs of initial UL BWP that are used for LP-WUS;
>>>>4: if frequency resource parameters are absent, UE determines frequency resource of LP-WUS is same as frequency resource of LP-SS;
>>>>4: if some of frequency resource parameters are absent, UE determines frequency resource of LP-WUS based on frequency resource of LP-SS (for example only bandwidth IE is present, UE determines that the reference frequency of LP-WUS is same as the reference frequency of LP-SS);
>>2: time resource parameters (at least followings):
>>>3: minimum_offset: indicating the time distance between a PO and associated WUS burst;
>>>3: number of LP-WUSs within a WUS burst
>>2: code resource parameters:
>>>3: mapping between subgroup-specific-sequences and subgroups (instead of explicit configuration, subgroup-specific-sequence can be derived from an predefined equation and input parameters for the equation, while the input parameter may includes short PCI and subgroup ID); and
>>2: SubgroupConfig:
>>>3: subgroupsNumPerPO.

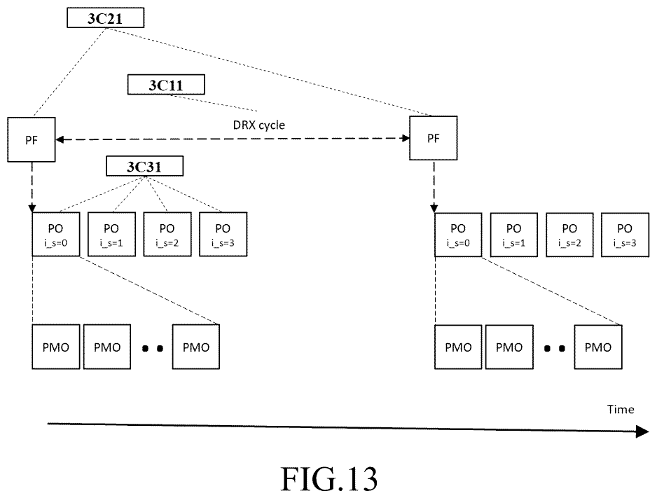

FIG. 13 illustrates paging monitoring and DRX in RRC_IDLE and RRC_INACTIVE.

The UE may use Discontinuous Reception (DRX) in RRC_IDLE and RRC_INACTIVE state in order to reduce power consumption. The UE monitors one paging occasion (PO) 3c31 per DRX cycle 3c11. A PO is a set of PDCCH monitoring occasions and can consist of multiple time slots (e.g. subframe or OFDM symbol) where paging DCI can be sent. One Paging Frame (PF) 3c21 is one Radio Frame and may contain one or multiple PO(s) or starting point of a PO.

In multi-beam operations, the UE assumes that the same paging message and the same Short Message are repeated in all transmitted beams and thus the selection of the beam(s) for the reception of the paging message and Short Message is up to UE implementation. The paging message is same for both RAN initiated paging and CN initiated paging.

The UE initiates RRC Connection Resume procedure upon receiving RAN initiated paging. If the UE receives a CN initiated paging in RRC_INACTIVE state, the UE moves to RRC_IDLE and informs NAS.

The PF and PO for paging are determined by the following formulae:
SFN for the PF is determined by:

(SFN+PF_offset) mod T=(T div N)*(UE_ID mod N).

Index (i_s), indicating the index of the PO is determined by:

i_s=floor (UE_ID/N) mod Ns.

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are same as for RMSI.

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0,1, . . . , X−1, K=1,2, . . ., S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

The following parameters are used for the calculation of PF and i_s above:
>1: T: DRX cycle of the UE.
>>2: If the UE does not operate in eDRX:
>>>3: T is determined by the shortest of the UE specific DRX value(s), if configured by RRC and/or upper layers and a default DRX value broadcast in system information. In RRC_IDLE state, if UE specific DRX is not configured by upper layers, the default value is applied.
>>2: In RRC_IDLE state, if the UE operates in eDRX and eDRX is configured by upper layers, i.e., T_E_DRX_CN:
>>>3: If T_E_DRX_CN is no longer than 1024 radio frames:
>>>>4: T =T_E_DRX_CN;
>>>3: else:
>>>>4: During CN configured PTW, T is determined by the shortest of UE specific DRX value, if configured by upper layers, and the default DRX value broadcast in system information.
>>2: In RRC_INACTIVE state, if the UE operates in eDRX and eDRX is configured by RRC, i.e., T_E_DRX_RAN, and/or upper layers, i.e., T_E_DRX_CN:
>>>3: If both T_E_DRX_CN and used T_E_DRX_RAN are no longer than 1024 radio frames, T=min{T_E_DRX_RAN, T_E_DRX_CN}.
>>>3: If T_E_DRX_CN is no longer than 1024 radio frames and no T_E_DRX_RAN is configured or used, T is determined by the shortest of UE specific DRX value configured by RRC (T_DRX_RAN) and T_E_DRX_CN.
>>>3: If T_E_DRX_CN is longer than 1024 radio frames:
>>>>4: If T_E_DRX_RAN is not configured or used:
>>>>>5: During CN configured PTW, T is determined by the shortest of the UE specific DRX value(s), if configured by RRC and/or upper layers, and a default DRX value broadcast in system information. Outside the CN configured PTW, T is determined by the UE specific DRX value configured by RRC;
>>>>4: else if used T_E_DRX_RAN is no longer than 1024 radio frames:
>>>>>5: During CN configured PTW, T is determined by the shortest of the UE specific DRX value, if configured by upper layers and T_E_DRX_RAN, and a default DRX value broadcast in system information. Outside the CN configured PTW, T is determined by T_E_DRX_RAN.
>>>>4: else if used T_E_DRX_RAN is longer than 1024 radio frames:
>>>>>5: During the overlapped part of CN configured PTW and RAN configured PTW, T is determined by the shortest of the UE specific DRX value configured by RRC, the UE specific DRX value configured by upper layers (if any), and a default DRX value broadcast in system information;
>>>>>5: During CN configured PTW and outside RAN configured PTW, T is determined by the shortest of the UE specific DRX value configured by upper layers (if any), and a default DRX value broadcast in system information;
>>>>>5: Outside CN configured PTW and during RAN configured PTW, T is determined by the UE specific DRX value configured by RRC.
>1: N: number of total paging frames in T
>1: Ns: number of paging occasions for a PF
>1: PF_offset: offset used for PF determination
>1: UE_ID:
>>2: If the UE operates in eDRX:
>>>3: 5G-S-TMSI mod 4096
>>2: else:
>>>3: 5G-S-TMSI mod 1024

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signalled in SIB1 for paging in the BWP configured by initialDownlinkBWP. For paging in a DL BWP other than the BWP configured by initialDownlinkBWP, the parameter firstPDCCH-MonitoringOccasionOfPO is signaled in the corresponding BWP configuration.

If the UE has no 5G-S-TMSI, for instance when the UE has not yet registered onto the network, the UE shall use as default identity UE_ID=0 in the PF and i_s formulas above. 5G-S-TMSI is a 48 bit long bit string. 5G-S-TMSI shall in the formulae above be interpreted as a binary number where the left most bit represents the most significant bit.

In RRC_INACTIVE state, if the UE supports inactiveStatePO-Determination and the network broadcasts ranPagingInIdlePO with value “true”, the UE shall use the same i_s as for RRC_IDLE state. Otherwise, the UE determines the i_s based on the parameters and formula above.

In RRC_INACTIVE state, if used eDRX value configured by upper layers is no longer than 1024 radio frames, the UE shall use the same i_s as for RRC_IDLE state.

In RRC_INACTIVE state, if used eDRX value configured by upper layers is longer than 1024 radio frames, during CN PTW, the UE shall use the same i_s as for RRC_IDLE state. Outside CN PTW, the UE shall use the i_s for RRC_INACTIVE state.

### Paging Early Indication

The UE may use Paging Early Indication (PEI) in RRC_IDLE and RRC_INACTIVE states in order to reduce power consumption. If PEI configuration is provided in system information, the UE in RRC_IDLE or RRC_INACTIVE state supporting PEI (except for the UEs expecting MBS group notification) can monitor PEI using PEI parameters in system information according to the procedure described below.

If lastUsedCellOnly is configured in system information of a cell, the UE monitors PEI in this cell only if the UE most recently received RRCRelease without noLastCellUpdate in this cell. Otherwise (i.e., if lastUsedCellOnly is not configured in system information of a cell), the UE monitors PEI in the camped cell.

The UE monitors one PEI occasion per DRX cycle. A PEI occasion (PEI-O) is a set of PDCCH monitoring occasions (MOs) and can consist of multiple time slots (e.g. subframes or OFDM symbols) where PEI can be sent. In multi-beam operations, the UE assumes that the same PEI is repeated in all transmitted beams and thus the selection of the beam(s) for the reception of the PEI is up to UE implementation.

The time location of PEI-O for UE's PO is determined by a reference point and an offset:
>1: The reference point is the start of a reference frame determined by a frame-level offset from the start of the first PF of the PF(s) associated with the PEI-O, provided by pei-FrameOffset in SIB1;
>1: The offset is a symbol-level offset from the reference point to the start of the first PDCCH MO of this PEI-O, provided by firstPDCCH-MonitoringOccasionOfPEI-O in SIB1.

The PDCCH MOs for PEI are determined according to pei-SearchSpace, pei-FrameOffset, firstPDCCH-MonitoringOccasionOfPEI-O and nrofPDCCH-MonitoringOccasionPerSSB-InPO if configured. When SearchSpaceId=0 is configured for pei-SearchSpace, the PDCCH MOs for PEI are same as for RMSI. UE determines first PDCCH MO for PEI-O based on pei-FrameOffset and firstPDCCH-MonitoringOccasionOfPEI-O, as for the case with SearchSpaceId>0 configured.

When SearchSpaceId=0 is configured for pei-SearchSpace, the UE monitors the PEI-O according to searchSpaceZero. When SearchSpaceId other than 0 is configured for pei-SearchSpace, the UE monitors the PEI-O according to the search space with the configured SearchSpaceId.

A PEI occasion is a set of ‘S*X’ consecutive PDCCH MOs, where ‘S’ is the number of actual transmitted SSBs determined according to ssb-PositionsInBurst in SIB1, and X is the nrofPDCCH-MonitoringOccasionPerSSB-InPO if configured or is equal to 1 otherwise. The [x*S+K]^{th} PDCCH MO for PEI in the PEI-O corresponds to the K^{th} transmitted SSB, where x=0,1, . . . , X−1, K=1,2, . . . , S. The PDCCH MOs for PEI which do not overlap with UL symbols (determined according to tdd-UL-DL-ConfigurationCommon) are sequentially numbered from zero starting from the first PDCCH MO for PEI in the PEI-O. When the UE detects a PEI within its PEI-O, the UE is not required to monitor the subsequent MO(s) associated with the same PEI-O.

If the UE detects PEI and the PEI indicates the subgroup the UE belongs to monitor its associated PO, the UE monitors the associated PO. If the UE does not detect PEI on the monitored PEI occasion or the PEI does not indicate the subgroup the UE belongs to monitor its associated PO, the UE is not required to monitor the associated PO.

If the UE is unable to monitor the PEI occasion (i.e. all valid PDCCH MO for PEI) corresponding to its PO, e.g. during cell re-selection, the UE monitors the associated PO according to clause 7.1.

### Subgrouping

If LP-WUS and subgrouping are configured, UEs monitoring the same PO can be divided into one or more subgroups. With subgrouping, the UE monitors the associated PO if the sequence corresponding to the subgroup the UE belongs to is detected during the LP-WUS occasions corresponding to its PO.

The following parameters are used for the determination of subgroup ID:
>1: subgroupsNumPerPO: total number of subgroups for both CN assigned subgrouping (if any) and UE_ID based subgrouping (if any) in a PO, which is broadcasted in system information;
>1: subgroupsNumForUEID: number of subgroups for UE_ID based subgrouping in a PO, which is broadcasted in system information.

UE's subgroup can be either assigned by CN or formed based on UE_ID:
>1: If subgroupsNumForUEID is absent in subgroupConfig, the subgroup ID based on CN assigned subgrouping, if available for the UE, is used in the cell.
>1: If both subgroupsNumPerPO and subgroupsNumForUEID are configured, and subgroupsNumForUEID has the same value as subgroupsNumPerPO, the subgroup ID based on UE_ID based subgrouping is used in the cell.
>1: If both subgroupsNumPerPO and subgroupsNumForUEID are configured, and subgroupsNumForUEID>subgroupsNumPerPO:
>>2: The subgroup ID based on CN assigned subgrouping, if available for the UE, is used in the cell;
>>2: Otherwise, the subgroup ID based on UE_ID based subgrouping is used in the cell.

If a UE has no CN assigned subgroup ID or does not support CN assigned subgrouping, and there is no configuration for subgroupsNumForUEID, the UE monitors the associated PO.

Paging with CN assigned subgrouping is used in the cell which supports CN assigned subgrouping. A UE supporting CN assigned subgrouping in RRC_IDLE or RRC_INACTIVE state can be assigned a subgroup ID (between 0 to 7) by AMF through NAS signalling. The UE belonging to the assigned subgroup ID monitors a LP-WUS sequences corresponding to the subgroup during LP-WUS burst corresponding to the PO of the UE.

Paging with UE_ID based subgrouping is used in the cell which supports UE_ID based subgrouping.

If the UE is not configured with a CN assigned subgroup ID, or if the UE configured with a CN assigned subgroup ID is in a cell supporting only UE_ID based subgrouping, the subgroup ID of the UE is determined by the formula below:

SubgroupID=(floor(UE_ID/(N*Ns)) mod subgroupsNumForUEID)+(subgroupsNumPerPO-subgroupsNumForUEID),

where:
N: number of total paging frames in T, which is the DRX cycle of RRC_IDLE state;
Ns: number of paging occasions for a PF;
UE_ID: 5G-S-TMSI mod X, where X is 32768, if eDRX is applied; otherwise, X is 8192;
subgroupsNumForUEID: number of subgroups for UE_ID based subgrouping in a PO, which is broadcasted in system information.

The UE belonging to the assigned subgroup ID monitors a LP-WUS sequences corresponding to the subgroup during LP-WUS burst corresponding to the PO of the UE.

The UE belonging to a subgroup ID monitors both subgroup specific LP-WUS sequence and a common LP-WUS sequence during the LP-WUS burst.

The UE may be configured by upper layers and/or RRC with an extended DRX (eDRX) cycle T_E_DRX_CN and/or T_E_DRX_RAN.

For CN paging, the UE operates in eDRX in RRC_IDLE or RRC_INACTIVE states if the UE is configured for eDRX by upper layers and eDRX-AllowedIdle is signalled in SIB1; otherwise, the UE does not operate in eDRX.

For RAN paging, the UE in RRC_INACTIVE state:
>: if the UE is configured for eDRX by ran-ExtendedPagingCycleConfig-r18 and eDRX-AllowedInactive-r18 is signalled in SIB1:
>>: operates in eDRX with an eDRX cycle T_E_DRX_RAN configured by extendedPagingCycle-r18;
>: else if the UE is configured for eDRX by ran-ExtendedPagingCycle-r17 and eDRX-AllowedInactive-r17 is signalled in SIB1:
>>: operates in eDRX with an eDRX cycle T_E_DRX_RAN configured by ran-ExtendedPagingCycle-r17;
>: else:
>>: does not operate in eDRX.

If the UE operates in eDRX with an eDRX cycle no longer than 1024 radio frames, it monitors POs as defined in 7.1 with configured eDRX cycle. Otherwise, a UE operating in eDRX monitors POs as defined in 7.1 during a periodic Paging Time Window (PTW) configured for the UE. The PTW is UE-specific and is determined by a Paging Hyperframe (PH), a starting position within the PH (PTW_start) and an ending position (PTW_end). PH, PTW_start and PTW_end are given by the following formula:

The PH for CN is the H-SFN satisfying the following equations:
H-SFN mod T_E_DRX_CN=(UE_ID_H mod T_E_DRX_CN), where
>: T_E_DRX_CN: UE-specific eDRX cycle in Hyper-frames, (T_E_DRX_CN=2, . . . , 1024 Hyper-frames) configured by upper layers.

The PH for RAN is the H-SFN satisfying the following equations:
H-SFN mod T_E_DRX_RAN=(UE_ID_H mod T_E_DRX_RAN), where
>: T_E_DRX_RAN: UE-specific eDRX cycle in Hyper-frames, (T_E_DRX_RAN=2, . . . , 1024 Hyper-frames) configured by RRC.

For CN configured PTW:
PTW_start denotes the first radio frame of the PH for CN that is part of the PTW and has SFN satisfying the following equation:
SFN=128* i_E_DRX_CN, where
>: i_E_DRX_CN=floor(UE_ID_H/T_E_DRX_CN) mod 8

PTW_end is the last radio frame of the PTW and has SFN satisfying the following equation:
SFN=(PTW_start+L*100−1) mod 1024, where
>: L=Paging Time Window (PTW) length (in seconds) configured by upper layers

For RAN configured PTW:

PTW_start denotes the first radio frame of the PH for RAN that is part of the PTW and has SFN satisfying the following equation:
SFN=128* i_E_DRX_CN, where
>: i_E_DRX_CN=floor(UE_ID_H/T_E_DRX_CN) mod 8

PTW_end is the last radio frame of the PTW and has SFN satisfying the following equation:
SFN =(PTW_start+L*100−1) mod 1024, where
>: L=Paging Time Window (PTW) length (in seconds) configured by RRC

UE_ID_H is defined as follows:
UE_ID_H: 13 most significant bits of the Hashed ID.

Hashed ID is defined as follows:

Hashed_ID is Frame Check Sequence (FCS) for the bits b31, b30 . . . , b0 of 5G-S-TMSI.

5G-S-TMSI=<b47, b46, . . . , b0>as defined in TS 23.003[23 ].

The 32-bit FCS shall be the ones complement of the sum (modulo 2) of Y1 and Y2

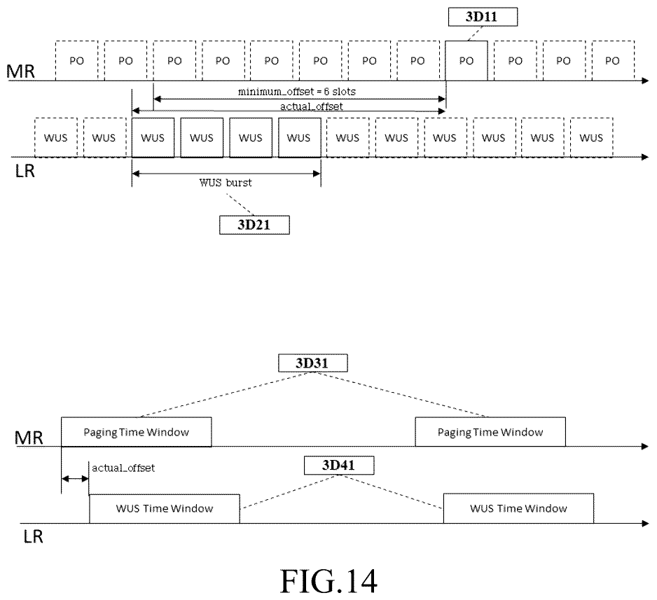

### FIG. 14: Identify WUS Burst

To identify WUS bursts to be monitored, UE may:
>1: determine its PO to monitor 3D11;
>1: determine WUS burst 3D21 associated with the PO:
>>2: UE first determine the time point which is apart from the beginning time point of determined PO by minimum_offset in advance; and
>>2: UE determines the WUS burst of which the beginning time point of its first LP-WUS is closest (in advance) to the time point;
>1: determine the actual_offset:
>>2: the actual offset is the time distance between the first LP-WUS of the associated WUS burst and the determined PO; and
>1: determine the next WUS burst to monitor based on the DRX cycle.

When WUS indicates that UE should receive the PO, UE identifies the time location of the PO based on the actual_offset.

If PTW 3D31 is configured for the UE, UE determines WTW (WUS Time Window) based on the actual_offset.

UE may:
>1: determine the beginning timing point of WTW 3D41 which is apart from the beginning time point of the PTW by actual_offset; and
>1: determine the length of WTW which is same as the PTW.

During a WUS burst, UE monitors a subgroup-specific-sequences and an all-subgroup-sequence. The length of the sequence is fixed (e.g. 4 bit). Each sequence is generated by a subgroup identity and a short PCI.

UE determines a subgroup that the UE belongs to based on SubgroupConfig in the system information and a subgroup ID assigned by AMF.

UE may generate the subgroup-specific-sequence based on the determined subgroup identity (e.g. SubgroupID) and short PCI that is indicated by LP-SS.

UE may generate the all-subgroup-sequence based on a specific subgroup identity (that is subgroupsNumPerPO+fixed integer) and short PCI. Alternatively, all-subgroup-sequence could be fixed in the specification.

UE may generate the subgroup-specific-sequence based on the determined subgroup identity (e.g. SubgroupID+number of all-subgroup-sequences+1) and short PCI that is indicated by LP-SS.

The base station transmits all-subgroup-sequence in case when it is necessary to:
>1: notify more than one subgroups to check the associated PO; or
>1: indicate BCCH modification other than SIB6, SIB7, SIB8; or
>1: indicate ETWS primary notification and/or an ETWS secondary notification.

It is possible to define more than one all-subgroup-sequences to indicate the limit the scope of notification (so that only subset of UEs to wake-up).

For example:
>1: first all-subgroup-sequence is to cause all UEs detecting the sequence to check the associated PO;
>1: second all-subgroup-sequence is to cause a first subset of UEs detecting the sequence to check the associated PO:
>>2: the first subset of UEs could be:
>>>3: UEs not configured with IDLE eDRX cycle longer than the modification period; or
>>>3: UEs configured with DRX cycle smaller than the modification period
>1: third all-subgroup-sequence is to cause a second subset of UEs detecting the sequence to check the associated PO;
>>2: the second subset of UEs could be:
>>>3: UEs configured with IDLE eDRX cycle longer than the modification period; or
>>>3: UEs configured with DRX cycle longer than the modification period;
>1: fourth all-subgroup-sequence is to cause a third subset of UEs detecting the sequence to check the associated PO;
>>2: the third subset of UEs could be:
>>>3: UEs configured to receive positioning system information (interested in receiving positioning system information).

UE is required to, during WTSs, monitor in WUS burst whether one of its target sequences is detected. Target sequences are determined as below.
>1: Target sequences for the first subset of UEs:
>>2: subgroup-specific-sequence; and
>>2: the first all-subgroup-sequence; and
>>2: the second all-subgroup-sequence;
>1: Target sequences for the second subset of UEs:
>>2: subgroup-specific-sequence; and
>>2: the first all-subgroup-sequence; and
>>2: the third all-subgroup-sequence;
>1: Target sequences for UEs that belongs to the first subset of UEs and the third subset of UEs:
>>2: subgroup-specific-sequence; and
>>2: the first all-subgroup-sequence; and
>>2: the second all-subgroup-sequence; and
>>2: the fourth all-subgroup-sequence;
>1: Target sequences for UEs that belongs to the second subset of UEs and the third subset of UEs:
>>2: subgroup-specific-sequence; and
>>2: the first all-subgroup-sequence; and
>>2: the third all-subgroup-sequence; and
>>2: the fourth all-subgroup-sequence.

For LP-WUSs of a WUS burst:
>1: if none of target sequences are detected in none of LP-WUSs of the WUS burst (e.g. if no sequences are detected in all LP-WUSs of the WUS burst, or if sequences detected at least once in LP-WUSs of the WUS burst are different from target sequences);
>>2: UE does not switch to MR mode (MR on/active; LR off/sleep/deactivated) and stay in LR mode (LR on/active; MR off/sleep/deactivated);
>>2: UE does not monitor the PO associated with the WUS burst;
>1: if at least one of target sequences are detected in at least one of LP-WUSs of the WUS burst;
>>2: UE switches from LR MODE to MR MODE;
>>2: UE monitor the PO associated with the WUS burst.

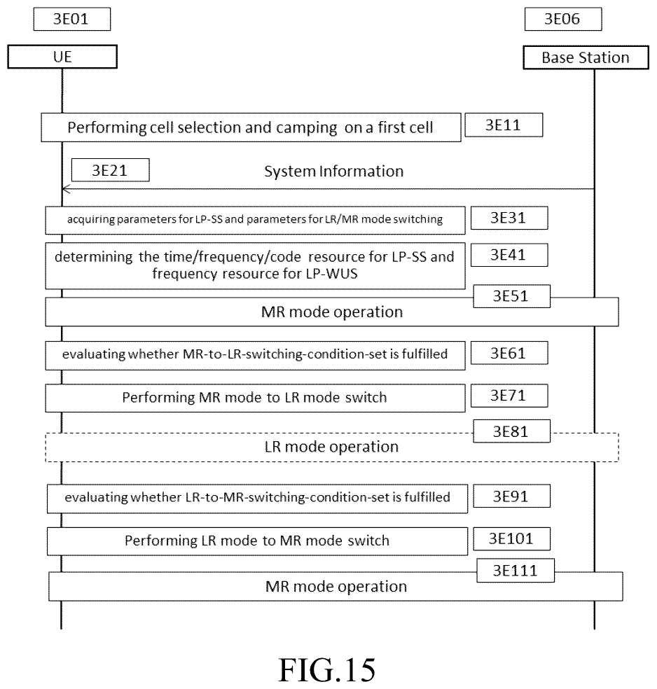

FIG. 15 illustrates the operation of UE and base station for MR to LR switching.

The coverage of LP-SS/LP-WUS could be smaller than SSB and PDCCH. It means when UE is out of LP-SS/LP-WUS coverage, the UE needs to switch back to MR mode. In addition, since LP-SS may not be appropriate for cell selection/cell reselection process, UE also needs to be in MR mode when cell selection/reselection is pending.

In general, UE performs neighboring cell measurement when serving cell channel quality is not good enough. It means that UE may stay in LR mode as long as:
>1: serving cell channel quality is good enough for UE to skip RRM measurement; and
>1: LP-SS quality is good enough for UE to provide the LP-SS/LP-WUS coverage.

In addition to radio condition (or even when radio condition is good), UE may need to perform RRM measurement to camp on the higher priority cell or to reselect the higher priority PLMN. To fulfil the radio conditions and operator's policy requirements together, UE consider various aspects for receiver mode selection.

UE may switch from MR mode to LR mode in case that all conditions of MR-to-LR-switching-condition-set are fulfilled. MR-to-LR-switching-condition-set are:
>1: condition on reference signal strength:
>>2: the serving cell fulfils:
>>>3: Srxlev>SIntraSearchP and Squal>SIntraSearchQ for x ms (to ensure that serving cell channel condition is good enough for UE to skip the neighbor cell measurement); and
>>>3: SS-RSRP >LP_ threshold_MR every y1 ms or y2 DRX cycles (to ensure that UE is in coverage of LP-SS/LP-WUS coverage);
>>>>4: different y2s are predefined depending on the length of DRX cycle and FR of the current serving cell and whether eDRX is configured;
>1: condition on configuration information in system information;
>>2: configuration information of LP-SS and LP-WUS are broadcast in system information of the current serving cell; and
>>2: configuration information of switching between LR and MR (e.g. LP_threshold_MR and LP_threshold_LR);
>1: condition on cell selection priority;
>>2: cell reselection priority of the serving cell (or serving frequency/current frequency) is highest (cell reselection priorities of the neighboring cells/frequencies are lower than or equal to the serving cell/serving frequency/current frequency); or
>>2: HSDN capable UE is camping on a HSDN cell.

UE may switch from LR mode to MR mode in case that at least one of LR-to-MR-switching-condition set is fulfilled. MR-to-LR-switching-condition-set are:

During LR mode, UE may perform following LR mode operations:
>1: use LP-WUR to receive LP-SS and LP-WUS;
>1: monitor/receive LP-WUS at LP-WUS occasion during WTW;
>1: receive/evaluate LP-SS during and out of WTW;
>1: evaluate whether the RSRP of LP-SS of the serving cell=<LP_threshold_LR every z1 ms or z2 DRX cycles;
>>2: different z2s are predefined depending on the length of DRX cycle and FR of the current serving cell and whether eDRX is configured;
>1: initiate switch from LR mode to MR mode in case that LR-to-MR-switching-condition-set are fulfilled.

During MR mode, UE may:
>1: perform tasks related to Camped Normally state;
>1: use MR to receive SSB and PDCCH;
>1: monitor/receive PDCCH at PO during PTW;
>1: receive/evaluate LP-SS during and out of WTW;
>1: evaluate whether the RSRP of SSS of the serving cell=<LP_threshold_LR every y1 ms or y2 DRX cycles;
>1: initiate switch from MR mode to LR mode in case that MR-to-LR-switching-condition-set are fulfilled.

Upon MR mode to LR mode switch, UE may:
>1: turn off/deactivate the MR (or put MR to deep sleep);
>1: turn on/activate LR.

Upon LR mode to MR mode switch, UE may:
>1: turn off/deactivate the LR (or put LR to deep sleep);
>1: turn on/activate MR.

For mode switching between MR mode and LR mode, UE performs followings.

UE performs cell selection and camps on a first cell 3E11. UE receive system information in the first cell 3E21.

UE acquires parameters for LP-SS and parameters for LR/MR mode switching from the system information 3E31.

UE determines the time/frequency/code resource for LP-SS and frequency resource for LP-WUS based on the acquired parameters 3E41.

UE performs MR mode operation 3E51.

UE evaluates whether MR-to-LR-switching-condition-set is fulfilled 3E61 based on:
condition w.r.t reference signal strength; and
condition w.r.t configuration information of LP-SS/LP-WUS; and
condition w.r.t cell reselection priority.

UE performs MR mode to LR mode switch 3E71 if MR-to-LR-switching-condition set is fulfilled.

UE performs LR mode operation 3E81.

UE evaluates whether LR-to-MR-switching-condition-set is fulfilled 3E91 based on:
condition w.r.t reference signal strength; or
condition w.r.t LP-WUS sequence detection.

UE performs LR mode to MR mode switch 3E101 if LR-to-MR-switching-condition-set is fulfilled.

UE performs MR mode operation 3E111.

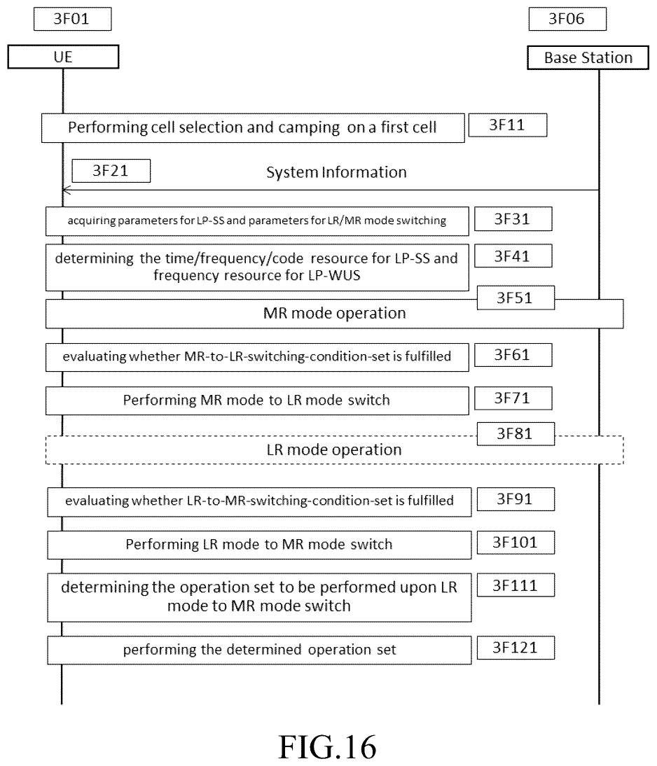

FIG. 16 illustrates another operation of UE and base station for MR to LR switching.

When UE is in LR mode, UE performs limited set of tasks to save battery power. It is important that UE switch back to the MR mode at an appropriate time to perform full set of tasks. Otherwise, UE may not be able to operate normally to provide proper service to the end user.

UE may perform LR to MR switching when at least one condition of the LR-to-MR switching condition set is fulfilled.

LR-to-MR switching condition set comprises:
>1: condition on reference signal strength:
>>2: RSRP of LP-SS of the serving cell=<LP_ threshold_LR;
>1: condition on PLMN search:
>>2: periodic search for a higher priority PLMN is initiated;
>>2: PLMN selection is initiated by user;
>1: condition on mobile originated data arrival:
>>2: new uplink data arrives/occurs while the UE is in LR mode;
>1: condition on mobile originated signaling;
>>2: mobile originated signaling e.g. periodic RAN Notification Area Update or periodic TAU arrives/occurs while the UE is in LR mode;
>1: condition on LP-WUS:
>>2: one of target sequence is detected in a LP-WUS occasion.

UE performs different set of operations upon LR-to-MR switching.

UE may:
>1: perform first set of actions in case that:
>>2: condition on mobile originated data arrival; or
>>2: condition on mobile originated signaling;
>1: perform second set of actions in case that:
>>2: condition on reference signal strength is fulfilled;
>1: perform third set of actions in case that:
>>2: condition on PLMN search is fulfilled; or
>1: perform fourth set of actions in case that:
>>2: condition on LP-WUS is fulfilled.

For the first set of actions, UE may:
>1: receive/measure SSBs in a SSB burst;
>1: select a SSB, that may be the SSB with the best RSRP;
>1: determine a RACH Occasion and a preamble based on the selected SSB;
>1: perform random access procedure based on the determination.

For the second set of actions, UE may:
>1: receive/measure SSBs;
>1: determine whether neighboring cell measurement is required based SS-RSRP and SS-RSRQ of measured SSBs;
>1: perform intra-frequency and inter-frequency measurement based on the determination.

For the third set of actions, UE may:
>1: scan all RF channels in the NR bands according to its capabilities;
>1: acquire system information of strongest cell of each carrier (each frequency);
>1: perform PLMN selection related tasks

For the fourth set of actions, UE may:
>1: monitor PDCCH with P-RNTI in the next PO associated with the UE;
>1: receive a Paging Message in PDSCH in case that PDCCH with P-RNTI is received; or acquire system information according to Short Message;
>1: fall back to the LR mode if neither PDCCH with P-RNTI nor Short Message with one or more specific bits set to one is received for n consecutive POs associated with the UE.

UE may stay MR mode when following conditions are fulfilled:
>1: UE in camped normally state has only dedicated priorities other than for the current frequency.

For mode switching between MR mode and LR mode, UE performs followings.

UE performs cell selection and camps on a first cell 3F11. UE receive system information in the first cell 3F21.

UE acquires parameters for LP-SS and parameters for LR/MR mode switching from the system information 3F31.

UE determines the time/frequency/code resource for LP-SS and frequency resource for LP-WUS based on the acquired parameters 3F41.

UE performs MR mode operation 3F51.

UE evaluates whether MR-to-LR-switching-condition-set is fulfilled 3F61 based on:
condition w.r.t reference signal strength; and
condition w.r.t configuration information of LP-SS/LP-WUS; and
condition w.r.t cell reselection priority.

UE performs MR mode to LR mode switch 3F71 if all conditions of MR-to-LR-switching-condition set is fulfilled.

UE performs LR mode operation 3F81.

UE evaluates whether LR-to-MR-switching-condition-set is fulfilled 3F91 based on:
condition on reference signal strength;
condition on PLMN search;
condition on MO-data;
condition on MO-signal; or
condition on LP-WUS;

UE determines to perform LR mode to MR mode switch 3F101 if at least one condition of LR-to-MR-switching-condition-set is fulfilled.

UE determines the operation set to be performed upon LR mode to MR mode switch based on the condition that triggered switching 3F111.

UE performs the determined operation set 3F121.

### IDLE Mode Operation

The UE shall scan all RF channels in the NR bands according to its capabilities to find available PLMNs and available CAGs upon switch-on or upon request from user. On each carrier, the UE shall search for the strongest cell and read its system information, in order to find out which PLMN(s) the cell belongs to. For operation with shared spectrum channel access, the UE may also read the system information of multiple strongest cell(s). If the UE can read one or several PLMN identities in the strongest cell or the multiple strongest cell(s) in case of operation with shared spectrum channel access, each found PLMN shall be reported to the NAS as a high quality PLMN (but without the RSRP value), provided that the following high-quality criterion is fulfilled:
>1: For an NR cell, the measured RSRP value shall be greater than or equal to −110 dBm.

Found PLMNs that do not satisfy the high-quality criterion but for which the UE has been able to read the PLMN identities are reported to the NAS together with their corresponding RSRP values and any associated CAG-ID. The quality measure reported by the UE to NAS shall be the same for each PLMN found in one cell.

The search for PLMNs may be stopped on request from the NAS. The UE may optimise PLMN search by using stored information e.g. frequencies and optionally also information on cell parameters from previously received measurement control information elements.

Once the UE has selected a PLMN, the cell selection procedure shall be performed in order to select a suitable cell of that PLMN to camp on.

In case that the selected PLMN is VPLMN (visited PLMN), a periodic search for a higher priority PLMN is performed. This involves MR so UE switches back to MR before the periodic search is performed and switches to LR after periodic search.

When camped normally, the UE shall perform the following tasks:
>1: monitor the paging channel of the cell as specified in clause 7 according to information broadcast in SIB1;
>1: monitor Short Messages transmitted with P-RNTI over DCI;
>1: monitor relevant System Information;
>1: perform necessary measurements for the cell reselection evaluation procedure;
>1: execute the cell reselection evaluation process on the following occasions/triggers:
>>2: UE internal triggers, so as to meet performance;
>>2: When information on the BCCH used for the cell reselection evaluation procedure has been modified.
>>2: When the network slice(s) and/or NSAG information received from NAS changes.

DCI format 1_0 is used for transmission of paging related information. The following information is transmitted by means of the DCI format 1_0 with CRC scrambled by P-RNTI:
>1: Short Messages Indicator—2 bits;
>>2: 01: Only scheduling information for Paging is present in the DCI;
>>2: 10: Only short message is present in the DCI;
>>2: 11: Both scheduling information for Paging and short message are present in the DCI;
>1: Short Messages—8 bits;
>1: Frequency domain resource assignment-n bits, n is determined based on number of PRBs of the BWP;
>1: Time domain resource assignment—4 bits;
>1: VRB-to-PRB mapping—1 bit;
>1: Modulation and coding scheme—5 bits;

DCI format/Short Message

The following information is transmitted by means of the DCI format 1_0 with CRC scrambled by SI-RNTI:
>1: Frequency domain resource assignment-n bits, n is determined based on number of PRBs of the BWP;
>1: Time domain resource assignment—4 bits;
>1: VRB-to-PRB mapping—1 bit;
>1: Modulation and coding scheme—5 bits;
>1: Redundancy version—2 bits;
>1: System information indicator—1 bit
>>2: 0 indicates SIB1;
>>2: 1 indicates SI message.

Short Message consists with 8 bit. Bit 1 is most significant bit. Each bit indicates followings:
>1: bit1 indicates systemInfoModification. If set to 1, it is indication of a BCCH modification other than SIB6, SIB7, SIB8 and posSIBs;
>1: bit 2 indicates etwsAndCmasIndication. If set to 1, it is indication of an ETWS primary notification and/or an ETWS secondary notification and/or a CMAS notification;
>1: bit 3 indicates stopPagingMonitoring. If set to 1, it is indication that the UE may stop monitoring PDCCH occasion(s) for paging in this Paging Occasion;
>1: bit 4 indicates systemInfoModification-eDRX. If set to 1, it is indication of a BCCH modification other than SIB6, SIB7, SIB8 and posSIBs. This indication applies only to UEs using IDLE eDRX cycle longer than the BCCH modification period.

If the UE receives a Short Message, the UE shall:
>1: if the UE is ETWS capable or CMAS capable, the etwsAndCmasIndication bit of Short Message is set, and the UE is provided with searchSpaceSIB1 and searchSpaceOtherSystemInformation on the active BWP or the initial BWP:
>>2: immediately re-acquire the SIB1;
>>2: if the UE is ETWS capable and si-SchedulingInfo includes scheduling information for SIB6:
>>>3: acquire SIB6 immediately;
>>2: if the UE is ETWS capable and si-SchedulingInfo includes scheduling information for SIB7:
>>>3: acquire SIB7 immediately;
>>2: if the UE is CMAS capable and si-SchedulingInfo includes scheduling information for SIB8:
>>>3: acquire SIB8 immediately;
>1: if the UE does not operate an IDLE eDRX cycle longer than the modification period and the systemInfoModification bit of Short Message is set:
>>2: apply the SI acquisition procedure from the start of the next modification period;
>1: if the UE operates an IDLE eDRX cycle longer than the modification period and the systemInfoModification-eDRX bit of Short Message is set:
>>2: apply the SI acquisition procedure from the start of the next eDRX acquisition period boundary.

### System Information

System information is broadcasted in a cell periodically. System information contains various information required for UEs in the cell to perform various activities.

System Information (SI) consists of a MIB and a number of SIBs, which are divided into Minimum SI and Other SI:

MIB contains cell barred status information and essential physical layer information of the cell required to receive further system information, e.g. CORESET #0 configuration. MIB is periodically broadcast on BCH.

SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.

SIB2 and SIB3 and SIB4 and SIB5 contain information for mobility (e.g. information on serving frequency and neighbouring cells).

SIB6 and SIB7 contain ETWS notifications;

SIB10 and SIB11 and SIB16 and SIB17 contain various information applicable for specific UEs such as Human-Readable Network Names (HRNN) of the NPNs and information related to idle/inactive measurements and information related to disaster roaming etc.

SIB19 contains a NTN-specific parameter. More specifically, SIB19 contains t-service field and t-stop field and t-start field.

The Low Power Wake-Up Signal (LP-WUS) technology was developed to reduce the power consumption of user equipment (UE). In conventional wireless communication systems, UEs need to remain in an active state continuously, leading to significant battery drain. LP-WUS technology addresses this issue.

LP-WUS is a signal used to wake up the UE from a low-power state, primarily received through a Low Power Wake-Up Radio (LP-WUR). The LP-WUR communicates with the main radio and activates it when specific conditions are met. For instance, upon receiving an LP-WUS from the base station, the LP-WUR checks if the signal corresponds to the UE's cell and then turns on the main radio to receive paging messages.

This technology plays a crucial role in extending the battery life of UEs and enhancing power efficiency. Additionally, LP-WUS can be applied across various wireless communication standards, with significant potential for use in 5G networks.

To achieve radio efficiency, it may be beneficial to wake up a plurality of UEs with a single LP-WUS. With more UEs grouped together, false alarm rate may increase. To strike the balance between radio efficiency and false alarm rate, the interactions between the UEs and network nodes should be designed with careful considerations.

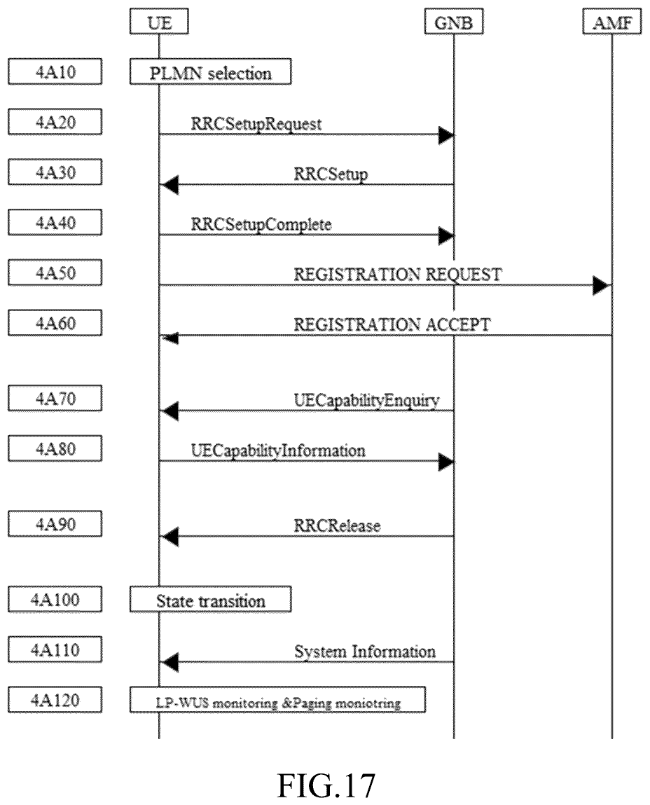

FIG. 17 illustrates operations of UE and GNB and AMF.

At 4A10, UE performs PLMN selection.

When UE is powered on, when it loses connection to the current network, or when it moves to a new location. UE performs PLMN search to find a PLMN to register to. The UE scans the available radio frequencies to detect broadcast signals from nearby base stations. These signals contain system information, including the PLMN identifiers.

UE selects a PLMN among available PLMNs based on stored PLMN list.

Once the UE has selected a PLMN, the cell selection procedure shall be performed in order to select a suitable cell of that PLMN to camp on.

When a suitable cell is selected, UE initiates RRC connection establishment procedure to perform NAS procedure for registration.

At 4A20, UE transmits to the GNB RRCSetupRequest message.

| | |
|---|---|
| RRCSetupRequest-IEs ::= | SEQUENCE { |
| ue-Identity | InitialUE-Identity, |
| establishmentCause | EstablishmentCause, |
| spare | BIT STRING (SIZE (1)) |

}

| | |
|---|---|
| InitialUE-Identity ::= | CHOICE { |
| ng-5G-S-TMSI-Part1 | BIT STRING (SIZE (39)), |
| randomValue | BIT STRING (SIZE (39)) |

}

| | |
|---|---|
| EstablishmentCause ::= | ENUMERATED { |
| | emergency, highPriorityAccess, mt-Access, mo-Signalling, |
| | mo-Data, mo-VoiceCall, mo-VideoCall, mo-SMS, |
| | spare6, spare5, spare4, spare3, spare2, spare1} |

```
  ng-5G-S-TMSI-Part1 is The rightmost 39 bits of 5G-S-TMSI.
  >1: UE sets the ue-Identity as follows:
  >>2: if upper layers provide a 5G-S-TMSI (e.g. if UE has a valid 5G-S-TMSI):
  >>>3: set the ue-Identity to ng-5G-S-TMSI-Part1;
  >>2: else (if it is the very first registration):
  >>>3: draw a 39-bit random value in the range 0..2³⁹-1 and set the ue-Identity to this
value.
```

GNB checks the ue-Identity and establishmentCause to determine whether to accept the request or reject the request. If determines to accept the request, GNB generates RRCSetup message.

At 4A30, GNB transmits to the UE RRCSetup message.

| | |
|---|---|
| RRCSetup ::= | SEQUENCE { |
| rrc-TransactionIdentifier | RRC-TransactionIdentifier, |
| criticalExtensions | CHOICE { |
| rrcSetup | RRCSetup-IEs, |
| criticalExtensionsFuture | SEQUENCE { } |

}
}

| | |
|---|---|
| RRCSetup-IEs ::= | SEQUENCE { |
| radioBearerConfig | RadioBearerConfig, |
| masterCellGroup | OCTET STRING (CONTAINING CellGroupConfig), |

...
}

Based on RRCSetup message, UE and GNB establishes SRB1 to exchange DCCH messages.

After establishment of SRB1, UE:
>: enters RRC_CONNECTED state;
>: considers the current cell to be the PCell; and
>: generates RRCSetupComplete message.

At 4A40, UE transmits to the GNB RRCSetupComplete message.

| | |
|---|---|
| RRCSetupComplete ::= | SEQUENCE { |
| selectedPLMN-Identity | INTEGER (1..maxPLMN), |
| registeredAMF | RegisteredAMFOPTIONAL, |

```
    guami-Type NUMERATED {native, mapped},
    s-NSSAI-List SEQUENCE (SIZE (1..maxNrofS-NSSAI)) OF S-NSSAI
OPTIONAL,
```

| dedicatedNAS-Message | DedicatedNAS-Message, | |
|---|---|---|
| ng-5G-S-TMSI-Value | CHOICE { | |
| ng-5G-S-TMSI | NG-5G-S-TMSI, | |
| ng-5G-S-TMSI-Part2 | BIT STRING (SIZE (9)) | |
| } | OPTIONAL, | |
| | ul-RRC-Segmentation-r16 | ENUMERATED {true} OPTIONAL, |
| | LP_WUS_supportIndication | ENUMERATED{true} |

```
OPTIONAL,
  ...
  }
```

| | |
|---|---|
| RegisteredAMF ::= | SEQUENCE { |
| plmn-Identity LMN-Identity | OPTIONAL, |

```
    amf-Identifier AMF-Identifier
  }
```

ng- 5G-S-TMSI-Part2: The leftmost 9 bits of 5G-S-TMSI.
registeredAMF: This field is used to transfer the GUAMI of the AMF where the UE is registered, as provided by upper layers.
selectedPLMN-Identity: Index of the PLMN or SNPN selected by the UE from the plmn-IdentityInfoList or npn-IdentityInfoList fields included in SIB1.
ul-RRC-Segmentation: This field indicates the UE supports uplink RRC segmentation of UECapabilityInformation.

LP_WUS_supportIndication: This field indicates the UE supports LP WUS operations in the frequency band of the current serving cell (or PCell). GNB uses this information to determine which AMF GNB forwards the first NAS message from the UE. If this indication is comprised in the RRCSetupComplete message, GNB may forward the first NAS message to the AMF that supports LP WUS operation.

UE performs NAS procedure for registration.

### Registration Request

At 4A50, UE transmits REGISTRATION REQUEST message to the AMF. The REGISTRATION REQUEST message is transmitted in ULInformationTransfer RRC message. The RRC message is transmitted via SRB1.

REGISTRATION REQUEST message may comprise:
>: 5GS mobile identity
>>: The purpose of the 5GS mobile identity information element is to provide either the SUCI, the 5G-GUTI, the IMEI, the IMEISV, the 5G-S-TMSI, the MAC address or the EUI-64.
>>: When comprised in the REGISTRATION REQUEST message, this IE comprises 5G-S-TMSI that is currently used by the UE.
>: 5GS DRX parameters for Requested DRX parameters
>>: The purpose of the 5GS DRX parameters information element is to indicate that the UE wants to use DRX and for the network to indicate the DRX cycle value to be used at paging.
>>: This field represents the DRX cycle parameter ‘T’ (among 32, 64, 128 and 256)
>>: If the UE wants to use or change the UE specific DRX parameters, the UE shall include the Requested DRX parameters IE in the REGISTRATION REQUEST message.
>: Extended DRX parameters for Requested extended DRX parameters
>>: The UE shall include this IE if the UE needs to use extended DRX or change the extended DRX parameters
>: PEIPS assistance information IE for Requested PEIPS assistance information
>>: The UE may include this IE if the UE supports NR paging subgrouping, the UE is not performing initial registration for emergency services, is not registered for emergency services and does not have an active emergency PDU session.
>>: The purpose of the PEIPS assistance information IE is to transfer the required assistance information to indicate the paging subgroup used when paging the UE.
>>: PEIPS assistance information IE comprises:
>>>: Paging subgroup ID value:
>>>>: This field contains the value (in decimal) of paging subgroup ID that is assigned by the AMF for paging the UE. This field has a valid range of values from (0-7). All other values are unused and shall be interpreted as 0 by this version of the protocol. It is CN assigned subgroup ID
>>>>: This field is comprised when PEIPS assistance information IE is comprised in REGISTARATION ACCEPT message;
>>>: UE paging probability information value:
>>>>: This field contains the value of UE paging probability information provided by the UE to the AMF. It represents the probability of the UE receiving the paging. This field has a valuvalid range of values from (p00-p100);
>>>>: This field is comprised when PEIPS assistance information IE is comprised in REGISTARATION REQUEST message;
>: LP-WUS assistance information IE for requested LP-WUS assistance information
>>: The UE may include this IE if the UE supports additional paging subgrouping (or second subgrouping) for LP-WUS (or UE supports LP-WUR operation), the UE is not performing initial registration for emergency services, is not registered for emergency services and does not have an active emergency PDU session.
>>: The purpose of the IE is to transfer the required assistance information to page UE with LP-WUS.
>>: This IE comprises:
>>>: Time-domain-distance-value:
>>>>: This field contains requested time domain distance between LP-WUS and associated PO. This field has a valid range of values from (n ms-m ms). The value reflects UE's capability on switching from LP-WUR operation to MR operation.

The UE may include Requested LP-WUS assistance information in case that:
>: the UE supports LP-WUS monitoring based on LP-WUS subgrouping (e.g. second subgrouping);
>: the UE is not performing initial registration for emergency services;
>: the UE is not registered for emergency services; and
>: the UE does not have an active emergency PDU session.

AMF determines whether the UE is eligible for registration to the PLMN based on the information (e.g. 5GS mobile identity) in the REGISTRATION REQUEST message. AMF generates AMF REGISTRATION REQUEST message.

### Registration Accept

At 4A60, AMF transmits the REGISTRATION ACCEPT message to the UE.
>: 5G-GUTI IE;
>>: This IE may be included to assign a 5G-GUTI to a UE.
>: Equivalent PLMNs;
>>: This IE may be included in order to assign an equivalent PLMNs list to a UE.
>: 5GS DRX parameters for Negotiated DRX parameters
>>: The network shall include this IE if the Requested DRX parameters IE was included in the REGISTRATION REQUEST message.
>>: UE uses the parameter for paging.
>: Extended DRX parameters for Negotiated extended DRX parameters
>>: The network shall include the Negotiated extended DRX parameters IE if:
>>>: the UE included the Requested extended DRX parameters IE in the REGISTRATION REQUEST message; and
>>>: the network supports eDRX and accepts the use of eDRX.
>: PEIPS assistance information IE for Negotiated PEIPS assistance information
>>: The network shall include the Negotiated PEIPS assistance information IE if:
>>>: the UE supports NR paging subgrouping;
>>>: the AMF supports and accepts the use of PEIPS assistance information for the UE; and
>>>: the UE is not performing initial registration for emergency services and does not have an active emergency PDU session.
>: LP-WUS assistance information IE for Negotiated LP-WUS assistance information
>>: The purpose of the IE is to transfer the required assistance information to page UE with LP-WUS.
>>: This IE comprises:
>>>: Time-domain-distance-value that is determined by the AMF to be used for monitoring PO following LP-WUS detection (e.g. LP-WUS that comprises information that subgroup2 of the UEs are required to monitor associated PO).
>>>>: If this field is absent, UE uses the value indicated in the Requested PEIPS assistance information.
>>>: Paging subgroup2 ID value:
>>>>: This field contains the value (in decimal) of paging subgroup2 ID that is assigned by the AMF for paging the UE. This field has a valid range of values from (0-7). All other values are unused and shall be interpreted as 1 (or specific value different from 0) by this version of the protocol.
>>>>: Network ensures that different values are assigned to Paging subgroup2 ID and Paging subgroupID for a UE.

Meanwhile, GNB may decide to acquire UE capability to allocate proper radio resource to the UE.

### UECapability

At 4A70, GNB transmits to the UE UECapabilityEnquiry message.

| | |
|---|---|
| UECapabilityEnquiry ::= | SEQUENCE { |
| rrc-TransactionIdentifier | RRC-TransactionIdentifier, |
| criticalExtensions | CHOICE { |
| ueCapabilityEnquiry | UECapabilityEnquiry-IEs, |
| criticalExtensionsFuture | SEQUENCE { } |

```
    }
  }
```

| | |
|---|---|
| UECapabilityEnquiry-IEs ::= | SEQUENCE { |
| ue-CapabilityRAT-RequestList | UE-CapabilityRAT-RequestList, |
| ue-CapabilityEnquiryExt | OCTET STRING (CONTAINING |
| UECapabilityEnquiry-v1560-IEs) | OPTIONAL -- Need N |

```
  }
  UECapabilityEnquiry-v1560-IEs ::= SEQUENCE {
```

| | |
|---|---|
| capabilityRequestFilterCommon | UE-CapabilityRequestFilterCommon |

OPTIONAL, -- Need N

| | |
|---|---|
| nonCriticalExtension | UECapabilityEnquiry-v1610-IEs |

```
OPTIONAL
  }
  UECapabilityEnquiry-v1610-IEs ::= SEQUENCE {
```

| | | |
|---|---|---|
| rrc-SegAllowed-r16 | ENUMERATED {enabled} | OPTIONAL, -- [symbol] |

N

| | | |
|---|---|---|
| nonCriticalExtension | SEQUENCE { } | OPTIONAL |

}

The capabilityRequestFilterCommon is an information element (IE) to specify the common capability request filters for the User Equipment (UE). Based on the IE, UE determines which capability information is comprised in the UECapabilityInformation.

GNB may decide to acquire LP-WUS related capability. If so, GNB includes LP-WUR-Request field in the message. The field comprises one bit information indicating that LP-WUR related capability is requested.

At 4A80, UE transmits to the GNB UECapabiliityInformation message.

UE includes LP-WUR-Capability IE in the message if LP-WUR-Request field was comprised in the UECapabilityEnquiry message.

LP-WUR-Capability IE may comprise:
>: Required time-domain-distance-value between LP-WUS and associated PO.
>: List of frequency bands where the UE supports LP-WUS operation.

UE and GNB may perform communication based on the reported capability and allocated radio resources.

When no more data remains, GNB may decide to transit the UE to RRC_IDLE state or RRC_INACTIVE state.

### RRCRelease

At 4A90, GNB transmits the RRCRelease message to the UE.

RRCRelease message may comprise noLastCellUpdate_LP_WUS field

Presence of the field indicates that the last used cell for LP_WUS shall not be updated. When the field is absent, the LR-capable UE shall update its last used cell with the current cell. The UE shall not update its last used cell with the current cell if the AS security is not activated. Based on this field, network can control paging monitoring method in a first cell (e.g. the cell where RRCRelease is received) and in a second cell (e.g. cell other than the first cell).

At 4A100, UE performs state transition based on the received RRCRelease message.

UE releases all radio resources, including release of the RLC entity, the BAP entity, the MAC configuration and the associated PDCP entity and SDAP for all established RBs (except for broadcast MRBs), BH RLC channels, Uu Relay RLC channels, PC5 Relay RLC channels and SRAP entity. UE enters RRC_IDLE and perform cell selection.

### System Information

At 4A110, UE receives system information in the selected cell. SIB1 comprises a ServingCellConfigCommonSIB IE. ServingCellConfigCommonSIB IE ocmprises DownlinkConfigCommonSIB IE.

| | |
|---|---|
| DownlinkConfigCommonSIB ::= | SEQUENCE { |
| frequencyInfoDL | FrequencyInfoDL-SIB, |
| initialDownlinkBWP | BWP-DownlinkCommon, |
| bcch-Config | BCCH-Config, |
| pcch-Config | PCCH-Config, |

```
    ...,
    [[
```

| | | |
|---|---|---|
| pei-Config-r17 | PEI-Config-r17 | OPTIONAL, -- Need R |

| | |
|---|---|
| initialDownlinkBWP-RedCap-r17 | BWP-DownlinkCommon |

```
OPTIONAL -- Need R
    ]],
    [[
```

| | | |
|---|---|---|
| frequencyInfoDL-v1800 | FrequencyInfoDL-SIB-v1800 | OPTIONAL |

```
-- Need R
    ]]
    LP-WUS-Config
  }
```

| | |
|---|---|
| PEI-Config-r17 ::= | SEQUENCE { |
| po-NumPerPEI-r17 | ENUMERATED {po1, po2, po4, po8}, |
| payloadSizeDCI-2-7-r17 | INTEGER (1..maxDCI-2-7-Size-r17), |
| pei-FrameOffset-r17 | INTEGER (0..16), |
| subgroupConfig-r17 | SubgroupConfig-r17, |

| | |
|---|---|
| lastUsedCellOnly-r17 | ENUMERATED {true} |

```
OPTIONAL, -- Need R
    ...
  }
```

| | |
|---|---|
| SubgroupConfig-r17 ::= | SEQUENCE { |
| subgroupsNumPerPO-r17 | INTEGER (1.. maxNrofPagingSubhroups-r17), |
| subgroupsNumForUEID-r17 | INTEGER (1.. maxNrofPagingSubgroups-r17) |

```
OPTIONAL, -- Need S
    ...
  }
  LP-WUS-Conif
```

| | |
|---|---|
| LP-WUS-Config ::= | SEQUENCE { |

frequency resource parameters frequency-resource-parameters

| | |
|---|---|
| time resource parameters | time-resource-parameters |

subgroup2Config

| | |
|---|---|
| lastUsedCellOnly_LP_WUS | ENUMERATED {true} OPTIONAL |
| LO_Frame_OffsetList | SEQUENCE (SIZE (1..maxLO-perPF)) |

LO_Frame_Offset
LO_symbol_OffsetListList SEQUENCE (SIZE (1..maxLO-perPF))
LO_symbol_Offset

| | |
|---|---|
| LP-SS_SSB_mappingList | SEQUENCE (SIZE (1..maxLP-SS)) LP- |

```
SS_SSB_mapping
    LP-SS-PositionsInBurst
  /// LP-SS-PositionsInBurst contains a bitmap, wherein each bit of the bitmap
corresponds to LP-SS index. Bit 0 indicates the corresponding LP-SS is not transmitted and
Bit 1 indicates the correspondign LP-SS is transmitted. ///
  LO_Frame_Offset ::= INTEGER (1..256)
  /// INTEGER n indicates n frames and n * 10 ms ///
  LO_symbol_OffsetListList ::= CHOICE {
```

| | |
|---|---|
| sCS15KH | SEQUENCE (SIZE (1..maxLMO-perLO)) OF INTEGER |

(0..139,

| | |
|---|---|
| sCS30KH | SEQUENCE (SIZE (1.. maxLMO-perLO)) OF INTEGER |

(0..279),

| | |
|---|---|
| sCS60KH | SEQUENCE (SIZE (1.. maxLMO-perLO)) OF INTEGER |

(0..559),

| | |
|---|---|
| sCS120KHZ | SEQUENCE (SIZE (1.. maxLMO-perLO)) OF INTEGER |

```
(0..1119),
              ...
    }
  /// INTEGER m of SCS x indicates m symbols of SCS x ///
  LP-SS_SSB_mapping ::= SEQUENCE {
    LP-SS index ,
    Mapped SSB SEQUENCE (SIZE ((1.. maxNrofLP-SSperSSB)) OF SSB-index
OPTIONAL, -- Need S
    ...
  }
  /// one or more SSBs are associated with (or quasi-collocated with) the LP-SS ///
  /// UE uses this information to determine downlink beam direction/downlink spatial
filter to apply for SSBs upon switching from LR to MR or vice versa///
  Subgroup2Config-r17 ::= SEQUENCE {
    Subgroup2sNumPerPO-r17 INTEGER (1.. maxNrofPagingSubgroup2s-r17),
    Subgroup2sNumForUEID-r17 INTEGER (1.. maxNrofPagingSubgroup2s-r17)
OPTIONAL, -- Need S
```

| | |
|---|---|
| UE_ID_OFFSET INTEGER (1..7) | OPTOINAL |

```
  ...
  }
```

### LP-WUS Monitoring and Paging Monitoring

At 4A120, UE performs LP-WUS monitoring and paging monitoring.

UE performs followings:
>: UE determines POs to be monitored as described in FIG. 13;
>: UE determines LOs associated with the POs;
>: UE determines LMO to be monitored;
>: UE monitors PMO or LMO to receives DCI for paging or LP-WUS (depending on whether LP-WUS-monitoring condition set is fulfilled or not).

LP-WUS comprises a bitmap and a CRC. Each bit of the bitmap corresponds to one or more subgroup2 IDs. If CN-assigned-subgroup2 is enabled in a cell, CN-assigned-subgroup2 is mapped to a bit. If UE-ID-based-subgroup2 is enabled in a cell, UE-ID-based-subgroup2 is mapped to a bit.

The size of bitmap is determined based on subgroup2sNumPerPO. The first bit of the bitmap maps to subgroup2 ID=0; The second bit of the bitmap maps to subgroup2 ID=1; and so on.

Paging monitoring is described in FIG. 13.

UE performs LP-WUS monitoring as below.

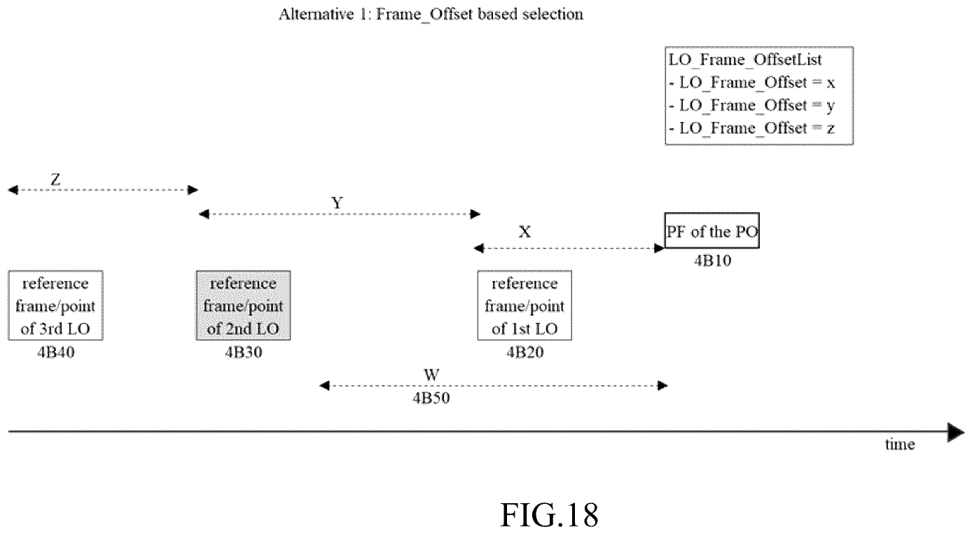

### FIG. 18 LO Selection

### LO Monitoring

The UE may use LP-WUS in RRC_IDLE and RRC_INACTIVE states in order to reduce power consumption.

The UE in RRC_IDLE or RRC_INACTIVE state can monitor LP-WUS in case that:
>: LP-WUS-config is provided in system information;
>: The UE is in LR mode (based on the current radio condition);
>: The UE supports LP-WUS operation;
>>: UE has transmitted Requested LP-WUS information IE to AMF; and/or
>>: UE has received from AMF Negotiated LP-WUS information IE.

Above are denoted as LP-WUS-monitoring condition set.

The UE can monitor LP-WUS using LP-WUS parameters in system information according to the procedure described below.

If lastUsedCellOnly_LP_WUS is configured in system information of a cell, the UE monitors LP-WUS in this cell only if the UE most recently received RRCRelease without noLastCellUpdate_LP_WUS in this cell. Otherwise (i.e., if lastUsedCellOnly_LP_WUS is not configured in system information of a cell or if lastUsedCellOnly_LP_WUS is not configured in system information and the UE most recently received RRCRelease with lastUsedCellOnly_LP_WUS), the UE monitors LP-WUS in the camped cell (provided that LP-WUS-monitoring condition set is fulfilled). It is to provide network to enhance the paging efficiency.

The UE monitors one LO (LP-WUS occasion) per DRX cycle (DRX cycle determined for PO monitoring as explained in FIG. 13). A LO is a set of LP-WUS monitoring occasions (LMOs) and can consist of multiple time slots (e.g. subframes or OFDM symbols) where LP-WUS can be sent. In multi-beam operations, the UE assumes that the same LP-WUS is repeated in all transmitted beams and thus the selection of the beam(s) for the reception of the LP-WUS is up to UE implementation. A LP-WUS in LMO is quasi-collocated with a LP-SS.

A PO is associated with one or more LOs. Number of LOs per PO is determined according to LO_Frame_OffsetList. LO_Frame_OffsetList comprises one or more LO_Frame_Offsets. The time location of first LO associated with the PO is determined according to the first LO_Frame_Offset; The time location of second LO associated with the PO is determined according to the second LO_Frame_Offset and so on.

LO_Frame_Offset field comprises an integer. The valid range of the integer is (1..64).

The time location of LOs for UE's PO is determined by a reference point and an offset:

The reference point of the first LO 4B20 is the start of a reference frame determined by first LO_Frame_Offset from the first PF 4B10 of the PF(s) associated with the LO;

The reference point of the second LO 4B30 is the start of a reference frame determined by second LO_Frame_Offset from the reference point of the first LO 4B20;

The reference point of the third LO 4B40 is the start of a reference frame determined by third LO_Frame_Offset from the reference point of the first LO 4B30.

UE determined/selects a LO from the set of LOs associated with a PO based on Time-domain-distance-value indicated in Negotiated (or Requested) LP-WUS information IE. UE compares the distance between each LO and PO. UE selects the LO of which reference point is at least Time-domain-distance-value apart from the PO/PF while closet to the PO/PF.

Assuming that:
>: Time-domain-distance-value is w;
>: x<w<x+y 4B50, then

UE selects the second LO 4B30 to monitor LP-WUS.

Each LO comprises one or more LMOs. Each LMO can carry a LP-WUS.

To monitor LP-WUS, UE determines/selects a LMO among LMOs of the selected LO based on symbol-level offset from the reference point to the start of the first LMO of the LO.

If UE selects the second LO, UE determines that each LMO of the second LO starts at a symbol indicated by LO_symbol_OffsetList.

LO_symbol_OffsetList is configured for each LO_Frame_Offset. LO_Symbol_OffsetList comprises one or more LO_Symbol_Offsets. The time location of first LMO associated with a LP-SS index 0 is determined according to the first LO_Symbol_Offset; The time location of second LMO associated with a LP-SS index 1 is determined according to the second LO_ Symbol_Offset and so on.

Each LP-SS can be transmitted in a different beam direction, allowing the network to cover a wider area and improve signal strength. The LP-SS index is used to identify the position of each LP-SS within a LP-SS window, and it also corresponds to a specific beam direction. The LP-SS window is time duration during when one or more LP-SSs covering all beam directions are transmitted.

The first LMO of a LO (or of a LMO set) is mapped to a LP-SS with the lowest LP-SS index. The n-th LMO of a LO (or of a LMO set) is mapped to a LP-SS with the n-th lowest LP-SS index.

UE monitors one or more LMOs in the selected LO. UE applies downlink beam direction (e.g. downlink spatial filter) corresponding to a LP-SS in receiving the LP-SS.

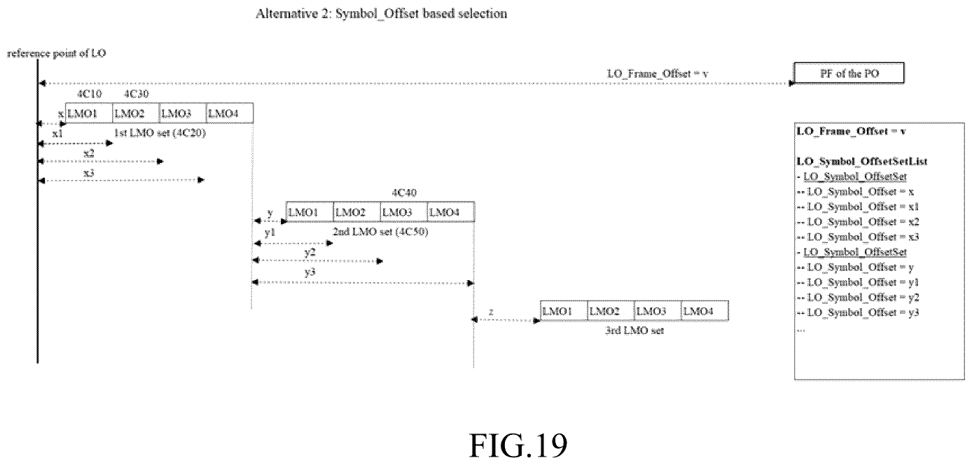

### FIG. 19 LO selection 2

As an alternative, followings can be applied.

A PO is associated with a LO. The LO consists of one or more LMO sets. Each LMO set consists of one or more LMOs. Each LMO is associated with (or quasi-collocated with) a LP-SS.

System information broadcast LO_Frame_Offset and LO_Symbol_OffsetListSet. LO_Symbol_OffsetListSet consists of one or more LO_Symbol_OffsetLists. Each LO_Symbol_OffsetList is mapped to a LMO set. Each LO_Symbol_OffsetSet consists of one or more LO_Symbol_Offset. Each LO_Symbol_Offset indicates the time location of a LMO within the LMO set.

For example:
>: A PO is associated with three LMO sets;
>: time location of first LMO 4C10 of the first LMO set 4C20 is determined by the first LO_Symbol_Offset of the first LO_Symbol_OffsetSet;
>: time location of second LMO 4C30 of the first LMO set 4C20 is determined by the second LO_Symbol_Offset of the first LO_Symbol_OffsetSet;
>: time location of third LMO 4C40 of the second LMO set 4C50 is determined by the third LO_Symbol_Offset of the second LO_Symbol_OffsetSet;
>: and so on

UE determines LMO set based on:
Time location of LMOS of the LMO set; and
Time-domain-distance-value.

UE determines LMO set of which all LMOs are at least Time-domain-distance-value apart from the first PF of the PO. If Time-domain-distance-value is w and w is smaller than [v−(x3+LMO4_length)] and greater than [v−(x3+LMO4_length)−(y3+LMO4_length)], UE selects the first LMO set 4C20 to monitor LP-WUS.

As another alternative, followings can be applied.

A LO is a set of ‘S*X’ consecutive LMOs, where ‘S’ is the number of actual transmitted LP-SSs determined according to LP-SS-PositionsInBurst in SIB1, and X is the nrofLMOPerLPSS-InLO if configured or is equal to 1 otherwise. Alternatively X is number of entries of LO_Frame_OffsetList. Alternatively X is number of entries in LO_Symbol_OffsetSetList. The [x*S+K]^{th} LMO for LO corresponds to the K^{th} transmitted LP-SS, where x=0,1, . . . , X−1, K=1,2, . . . , S. The LMO which do not overlap with UL symbols (determined according to tdd-UL-DL-ConfigurationCommon) are sequentially numbered from zero starting from the first LMO. When the UE detects a LP-WUS within its LO, the UE is not required to monitor the subsequent LMO(s) associated with the same LO.

UE monitors LMOs that are:
at least Time-domain-distance-value apart from the first PF of the PO; and
quasi-collocated with good (or detected) LP-SSs.

When UE detects LP-WUS in a LMO, UE performs followings.

If the UE detects LP-WUS and the LP-WUS indicates the subgroup2 the UE belongs to monitor its associated PO, the UE:
switches to MR-mode; and
monitors the associated PO (or PEI if configured).

If the UE does not detect LP-WUS on the monitored LMOs or the LP-WUS does not indicate the subgroup2 the UE belongs to monitor its associated PO, the UE:
stays in LR-mode; and
is not required to monitor the associated PO.

If the UE is unable to monitor the LO (i.e. all valid LMOs) corresponding to its PO, e.g. during cell re-selection, the UE monitors the associated PO.

### Subgrouping

If LP-WUS and a second subgrouping are configured, UEs monitoring the same PO can be divided into one or more subgroup2s. With second subgrouping, the UE monitors the associated PO if a bit corresponding to the subgroup2 the UE belongs to is set to a first value during the LOs corresponding to its PO.

The following parameters are used for the determination of subgroup ID:
>1: subgroup2sNumPerPO: total number of subgroups for both CN assigned second subgrouping (if any) and UE_ID based second subgrouping (if any) in a PO, which is broadcasted in system information;
>1: subgroup2sNumForUEID: number of subgroup2s for UE_ID based subgrouping in a PO, which is broadcasted in system information.

UE's subgroup2 can be either assigned by CN or calculated based on UE_ID:
>1: If subgroup2sNumForUEID is absent in subgroup2Config, the subgroup2 ID based on CN assigned subgrouping, if available for the UE, is used in the cell.
>1: If both subgroup2sNumPerPO and subgroup2sNumForUEID are configured, and subgroup2sNumForUEID has the same value as subgroup2sNumPerPO, the subgroup2 ID based on UE_ID based subgrouping is used in the cell.
>1: If both subgroup2sNumPerPO and subgroup2sNumForUEID are configured, and subgroup2sNumForUEID>subgroup2sNumPerPO:
>>2: The subgroup2 ID based on CN assigned second subgrouping, if available for the UE, is used in the cell;
>>2: Otherwise (e.g. subgroup2sNumForUEID <subgroup2sNumPerPO), the subgroup2 ID based on UE_ID based second subgrouping is used in the cell.

Alternatively,
1: If subgroup2sNumForUEID is absent in subgroup2Config, the subgroup2 ID based on CN assigned subgrouping, if available for the UE, is used in the cell.
>1: If both subgroup2sNumPerPO and subgroup2sNumForUEID are configured, the subgroup2 ID based on UE_ID based subgrouping is used in the cell.

If a UE has no CN assigned subgroup2 ID or does not support CN assigned second subgrouping, and there is no configuration for subgroup2sNumForUEID, the UE monitors the associated PO.

Paging with CN assigned second subgrouping is used in the cell which supports CN assigned second subgrouping. A UE supporting CN assigned second subgrouping in RRC_IDLE or RRC_INACTIVE state can be assigned a subgroup2 ID (between 0 to 7) by AMF through NAS signalling. The UE belonging to the assigned subgroup2 ID monitors a LP-WUS bit corresponding to the subgroup2 during LO corresponding to the PO of the UE.

Paging with UE_ID based second subgrouping is used in the cell which supports UE_ID based subgrouping.
>1: If the UE is not configured with a CN assigned subgroup2 ID, or if the UE configured with a CN assigned subgroup2 ID is in a cell supporting only UE_ID based second subgrouping (e.g., subgroup2sNumForUEID>subgroup2sNumPerPO);
>>2: the subgroup2 ID of the UE is determined by the formula below:

Subgroup2ID=(floor(UE_ID/(N*Ns)+UE_ID_OFFSET) mod subgroup2sNumForUEID)+(subgroup2sNumPerPO-subgroup2sNumForUEID),
where:
N: number of total paging frames in T, which is the DRX cycle of RRC_IDLE state (for UE in RRC_IDLE state) or RRC_INACTIVE state (for UE in RRC_INACTIVE state);
Ns: number of paging occasions for a PF;
UE_ID: 5G-S-TMSI mod X, where X is 32768, if eDRX is applied; otherwise, X is 8192;
UE_ID_OFFSET: an integer in (1..7). If both PEI and LP-WUS are configured in a cell, this parameter is used to have SubgroupID for PEI and Subgroup2ID FOR LP-WUS being different each other. This parameter is broadcast in system information. If this parameter is absent, UE_ID_OFFSET is zero;
Subgroup2sNumForUEID: number of subgroup2s for UE_ID based second subgrouping in a PO, which is broadcasted in system information.

The UE belonging to the assigned subgroup ID monitors a LP-WUS according to the subgroup during selected LMOs of LOs corresponding to the PO of the UE.

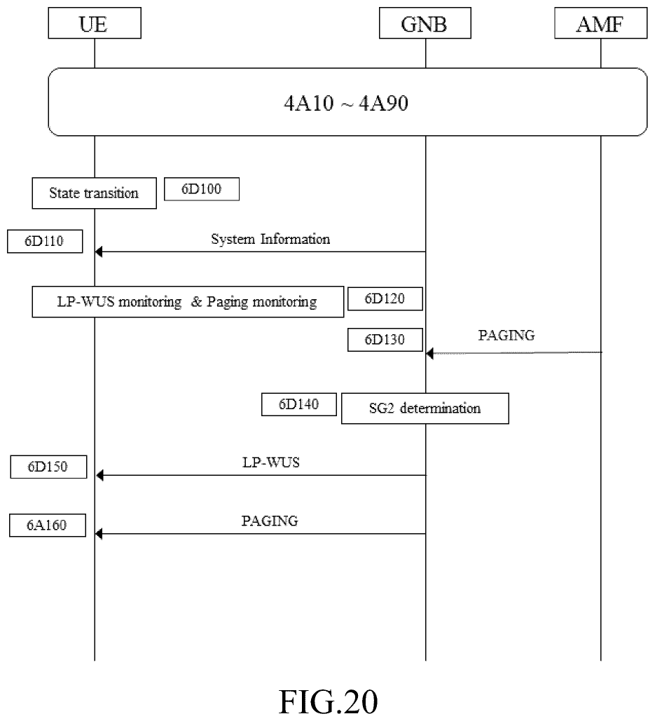

FIG. 20 illustrates another operation of UE and GNB and AMF.

UE and GNB and AMF perform from 6A10 up to 6A90.

At 6D100, UE performs State transition based on the received RRCRelease message.

If the RRCRelease meassge comprises SuspendConfig, UE performs state transition to RRC_INACTIVE and cell selection.

At 6D110, UE receives system information in the selected cell. SIB1 comprises a ServingCellConfigCommonSIB IE. ServingCellConfigCommonSIB IE ocmprises DownlinkConfigCommonSIB IE.

DownlinkConfigCommonSIB further comprises PCCH-Config IE.

| | |
|---|---|
| PCCH-Config ::= | SEQUENCE { |
| defaultPagingCycle | PagingCycle, |
| nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |

},

| | |
|---|---|
| ns | ENUMERATED {four, two, one}, |

firstPDCCH-MonitoringOccasionOfPO CHOICE {

| | |
|---|---|
| sCS15KHZoneT | SEQUENCE (SIZE |

(1..maxPO-perPF)) OF INTEGER (0..139),

sCS30KHZoneT-SCS15KHZhalfT

SEQUENCE (SIZE (1..maxPO-perPF)) OF INTEGER (0..279),

sCS60KHZoneT-SCS30KHZhalfT-SCS15KHZqyarterT

SEQUENCE (SIZE 1..maxPO-perPF)) OF INTEGER (0..559),

| | |
|---|---|
| | sCS120KHZoneT-SCS60KHZhalfT-SCS30KHZquarterT- |
| SCS15KHZonEighthT | SEQUENCE (SIZE (1..maxPO-perPF)) OF INTEGER |

(0..1119),
sCS120KHZhalfT-SCS60KHZquarterT-SCS30KHZoneEighthT-

| | |
|---|---|
| SCS15KHZoneSixteenthT | SEQUENCE (SIZE (1..maxPO-perPF)) OF INTEGER |

(0..2239),
sCS480KHZhalfT-SCS60KHZquarterT-SCS30KHZoneEighthT-

| | |
|---|---|
| SCS30KHZoneSixteenthT | SEQUENCE (SIZE (1..maxO-perPF)) OF INTEGER |

(0..4479),
sCS480KHZhalfT-SCS120KHZoneEighthT-SCS60KHZoneSixteenthT
SEQUENCE (SIZE (1.maxPO-perPF)) OF INTEGER (0..8959),

sCS480KHZquarterT-SCS120KHZoneSixteenthT

```
SEQUENCE (SIZE (1..maxPO-perPF)) OF INTEGER (0..17919)
    } OPTIONAL, -- Need R
    ...,
    [[
```

| | |
|---|---|
| nrofPDCCH-MonitoringOccasionPerSSB-InPO-r16 | INTEGER (2..4) |

```
OPTIONAL -- Cond SharedSpectrum2
    ]],
    [[
```

| | |
|---|---|
| ranPagingInIdlePO-r17 | ENUMERATED {true} |

OPTIONAL, -- Need R
firstPDCCH-MonitoringOccasionOfPO-v1710 CHOICE {

| | |
|---|---|
| sCS480KHZoneEighthT | SEQUENCE (SIZE (1..maxPO-perPF)) OF |

INTEGER (0..35839),

| | |
|---|---|
| sCS480KHZoneSixteenthT | SEQUENCE (SIZE (1..maxPO-perPF)) OF |

INTEGER (0..71679)
}

defaultPagingCycle is default paging cycle, used to derive ‘T’ in TS 38.304[20 ]. Value rf32 corresponds to 32 radio frames, value rf 64 corresponds to 64 radio frames and so on.

firstPDCCH-MonitoringOccasionOfPO points out the first PDCCH monitoring occasion for paging of each PO of the PF.

nAndPagingFrameOffset is used to derive the number of total paging frames in T (corresponding to parameter N) and paging frame offset (corresponding to parameter PF_offset). A value of oneSixteenthT corresponds to T/16, a value of oneEighthT corresponds to T/8, and so on.

ns is number of paging occasions per paging frame.

ranPagingInIdlePO indicates that the network supports to send RAN paging in PO that corresponds to the i_s as determined by UE in RRC_IDLE state.

At 6D120, UE performs LP-WUS monitoring and paging monitoring.

UE performs followings:
>: UE determines PFs to be monitored based on:
>>: parameters in PCCH-Config; and
>>: parameters provided in RRCRelease message;
>: UE determines POs to be monitored as described in FIG. 13 based on:
>>: in case that ranPagingInIdlePO is absent:
>>>: parameters in PCCH-Config; and
>>>: parameters provided in RRCRelease message;
>>: in case that ranPagingInIdlePO is present:
>>>: parameters in PCCH-Config; and
>>>: parameters provided in REGISTRATION ACCEPT message;
>: UE determines LOs associated with the POs;
>: UE determines LMO to be monitored;
>: UE monitors PMO or LMO to receives DCI for paging or LP-WUS (depending on whether LP-WUS-monitoring condition set is fulfilled or not).

In RRC_INACTIVE state, if used eDRX value configured by upper layers is longer than 1024 radio frames:
>: during WTW, to determine LO and reference PF:
>>: the UE shall use the same i_s as for RRC_IDLE state;
>>>: i_s as for RRC_IDLE state is i_s that is determined based on a first DRX cycle value (T that would have been used if UE is in RRC_IDLE);
>>: the UE shall determine PF based on a second DRX cycle value (T selected for outside of PTW for RRC_INACTIVE state);
>: outside of WTW, to determine LO and reference PF:
>>: the UE shall use i_s for RRC_INACTIVE state;
>>>: i_s for RRC_INACTIVE state is i_s that is determined based on a third DRX cycle value (T selected for outside of PTW for RRC_INACTIVE state); and
>>: the UE shall determine PF based on the third DRX cycle value.

At 6D130, to page a UE, AMF sends a PAGING message to the base station. If the UE supports LP-WUS (if the UE has indicated in a REGISTRATION REQUEST message that UE supports the LP-WUS), AMF includes a LP-WUS Assistance Information in the PAGING message.

The Paging message comprises following IEs:
>: UE Paging Identity IE that comprises 5G-S-TMSI IE
>: Paging DRX IE that indicates the Paging DRX
>: NR Paging eDRX Information IE that indicates the NR Paging eDRX parameters. This IE comprises NR Paging eDRX Cycle and NR Paging Time Window.

PEIPS Assistance Information IE provides the information related to CN paging subgrouping for a particular UE. This IE comprises CN Subgroup ID for the UE.

LP-WUS Assistance Information provides the information related to CN paging second subgrouping for a particular UE. This IE comprises an IE for time-domain-distance-value and CN Paging subgroup2 ID. 5G-S-TMSI IE is used for security reasons, to hide the identity of a subscriber. This IE consists of AMF Set ID and AMF Pointer and 5G-TMSI. AMF Set ID is used to uniquely identify an AMF Set within the AMF Region. This IE is a bit string of 10 bit.

AMF Pointer IE is used to identify one or more AMF(s) within the AMF Set. This IE is a bit string of 6 bit.

5G-TMSI is unique within the AMF that allocated it. It is 4 byte octet string.

At 6D140, based on PAGING message, GNB performs followings:
>: GNB determines PO of the UE based on Paging DRX IE;
>: GNB determines LO of the UE based on time-domain-distance-value; and
>: GNB determines Subgroup2 of the UE based on UE_ID and UE_ID_OFFSET or based on CN Subgroup2 ID.

At 6D150, based on determination, GNB transmits LP-WUS in LMOs of the determined LO.

GNB set a bit corresponding to the subgroup2 of the UE to a specific value (e.g. 1). GNB transmits same LP-WUS in all LMO of the LO.

GNB sets bits in the LP-WUS based on subgroups2s of the UEs that are to be paged in the associated PO.

Upon receiving LP-WUS (comprising bit corresponding to the subgroup2 set to 1) during a LMO of associated LO, UE performs LR-to-MR switching.

UE determines PO associated with LO. UE determines PMOs of the PO to be monitored PDCCH for paging DCI.

UE may:
>: perform beam sweeping for SSBs to determine the best SSBs and downlink beam direction (downlink spatial RX filter);
>: receive one or more PMOs based on determined downlink beam direction (spatial RX filter).

### QCL with SSB

Alternatively, UE may:
>: determines the downlink beam directions (e.g. quasi-colocation relations) associated with PMOs based on LMO-PMO association (that is given by LMO_PMO_mappingList IE);
>>: each LP-SS (LMO) is associated with each SSB (PMO) (e.g. one to one mapping) based on LP-SS index and SSB index (or based on LMO index and PMO index) in case that:
>>>: LMO_PMO_mappingList IE is absent in LP-WUS-Config; and
>>>: number of LP-SSs (or LMOs) and number of SSBs (or PMOs) are identical;
>>: each LP-SS (LMO) is associated with one or more SSBs (PMOs) based on LMO_PMO_mapping IE in case that:
>>>: LMO_PMO_mappingList IE is present in LP-WUS-Config;
>: receive one or more PMOs based on downlink beam directions of the associated/mapped LMOs.

A LMO n (n-th LMO of LMOs of a LO) is quasi-colocated with a PMO n (n-th PMO of PMOs of PO) in case that number of LMOs and number of PMOs are identical.

A LP-SS n (n-th LP-SS of a LP-SS burst) is quasi-coloated with a SSB n (n-th SSB of a SSB burst) in case that number of LP-SSs per LP-SS burst and number of SSBs per SSB burst are identical.

Each LP-WUS ocassion is quasi-colocated with a SSB. Each LP-SS ocassioin is quasi-colocated with a SSB. Each LP-WUS ocassion is quasi-colocated with a LP-SS occasion.

| | |
|---|---|
| LMO_PMO_mappingList | SEQUENCE (SIZE (1..maxLP-SS)) |

LMO_PMO _mapping

| | |
|---|---|
| LMO_PMO_mapping ::= | SEQUENCE { |

LMO index ,

| | |
|---|---|
| Mapped PMO | SEQUENCE (SIZE ((1.. maxNrofLP-SSperSSB)) OF PMO- |
| index | OPTIONAL, -- Need S |

Alternatively, UE may:
>: determines the downlink beam directions associated with SSBs based on LP-SS_SSB_mappingList IE;
>>: each LP-SS is associated with each SSB based on LP-SS index and SSB index (e.g. one to one mapping) in case that:
>>>: LP-SS_SSB_mappingList IE is absent in LP-WUS-Config; and
>>>: number of LP-SSs and number of SSBs are identical;
>>: each LP-SS is associated with one or more SSBs based on LP-SS_SSB_mappingList IE in case that:
>>>: LP-SS_SSB_mappingList IE is present in LP-WUS-Config;
>: receive one or more PMOs based on downlink beam directions of the associated/mapped SSBs and LP-SS.

At 6A160, GNB transmits PAGING message. GNB first transmits paging DCI in the PO. The paging DCI (e.g. DCI format 1_0 scramble d with P-RNTI) comprises:
>: Short Messages Indicator;
>: Short Messages;
>: Frequency domain resource assignment for Paging message;
>: Time domain resource assignment for Paging message.

GNB transmits the Paging according to the scheduling information in the paging DCI.

The paging message comprises a PagingRecordList IE.

| | |
|---|---|
| PagingRecordList ::= | SEQUENCE (SIZE(1..maxNrofPageRec)) OF |

PagingRecord

| | |
|---|---|
| PagingRecord ::= | SEQUENCE { |
| ue-Identity | PagingUE-Identity, |
| accessType | ENUMERATED {non3GPP} OPTIONAL, -- Need N |

```
    ...
  }
```

| | |
|---|---|
| PagingUE-Identity ::= | CHOICE { |
| ng-5G-S-TMSI | NG-5G-S-TMSI, |
| fullI-RNTI | I-RNTI-Value, |

```
    ...
  }
```

If Short Message is present, UE performs appropriate actions according to contents of the Short Message.

If one of PagingRecord matches with UE identifier, UE performs appropriate actions. For example if PagingUE-Identity is fullI-RNTI, UE initiates RRC connection resume procedure. If PagingUE-Identity is ng-5G-S-TMSI, UE initiates RRC connection establishment procedure.

A LO is a set of ‘S*X’ consecutive LMOs.

‘S’ is:
>: the number of actual transmitted SSBs determined according to ssb-PositionsInBurst in SIB1;
>: the number of actual transmitted LP-SSs determined according to ssb-PositionsInBurst in SIB1; or
>: the number of actual transmitted SSs.

X is the nrofLMOPerSS-InLO if configured or is equal to 1 if not configured.

The [x*S+K]^{th} LMO in the LO corresponds to the K^{th} transmitted SS, where x=0,1, . . . , X−1, K=1,2, . . . , S.

The LMO is transmitted over NumberOfSymbolsPerLmo non-UL symbols. Non-UL symbol is a DL symbol or flexible symbol. Whether a symbol is DL symbol or UL-symbol or flexible symbol is determined according to TDD-UL-DL-ConfigCommon.

NumberOfSymbolsPerLmo is inclucded in SIB1. It includes ‘ENUMERATED {sym12, sym16, sym20}’. sym16 means that a LMO occupies 20 specific symbols.

Specific symbol is:
>: a symbol that is not UL symbol according to TDD-UL-DL-ConfigCommon;
>: not overlapped with SSB symbol; and
>: not overlapped with PRACH.

SS is either SSB or LP-SS

nrofLMOPerSS-InLO is included in SIB1. It includes ‘ENUMERATED {n2, n4, n6}’. n2 means that 2 LMOs per LO.

An LP-SS burst is transmitted periodically. The periodicity of LP-SS burst is indicated by lpSsPeriodicity which includes ‘ENUMERATED {ms160, ms320}’

The starting point of LP-SS burst is indicated by timeDomainOffsetLpSS which includes ‘INTEGER (0..319)’. It is an subframe offsert from the first symbol of SFN 0. n means that LP-SS burst begins at subframe n from SFN 0 (or n ms from SFN 0).

An LP-SS burst consists of m actually transmitted LP-SSs. LP-SSs of a LP-SS burst are sequentially numbered from 0 .

UE determines actually transmitted LP-SSs based on ssb-PositionsInBurst. Since there is one to one relationship between SSB and LP-SS, if SSB n is indicated as actually transmitted, LP-SS n is also actually transmitted.

| | |
|---|---|
| TDD-UL-DL-ConfigCommon ::= | SEQUENCE { |
| referenceSubcarrierSpacing | SubcarrierSpacing, |
| pattern1 | TDD-UL-DL-Pattern, |

| | |
|---|---|
| pattern2 | TDD-UL-DL-Pattern |

```
OPTIONAL, -- Need R
    ...
  }
```

| | |
|---|---|
| TDD-UL-DL-Pattern ::= | SEQUENCE { |
| dl-UL-TransmissionPeriodicity | ENUMERATED {ms0p5, ms0p625, ms1, |

ms1p25, ms2, ms2p5, ms5, ms10},

| | |
|---|---|
| nrofDownlinkSlots | INTEGER (0..maxNrofSlots), |
| nrofDownlinkSymbols | INTEGER (0..maxNrofSymbols-1), |
| nrofUplinkSlots | INTEGER (0..maxNrofSlots), |
| nrofUplinkSymbols | INTEGER (0..maxNrofSymbols-1), |

...,
}

dl-UL-TransmissionPeriodicity: Periodicity of the DL-UL pattern.

nrofDownlinkSlots: Number of consecutive full DL slots at the beginning of each DL-UL pattern.

nrofDownlinkSymbols: Number of consecutive DL symbols in the beginning of the slot following the last full DL slot (as derived from nrofDownlinkSlots).

nrofUplinkSlots: Number of consecutive full UL slots at the end of each DL-UL pattern.

nrofUplinkSymbols: Number of consecutive UL symbols in the end of the slot preceding the first full UL slot (as derived from nrofUplinkSlots).

| | |
|---|---|
| ssb-PositionsInBurst | SEQUENCE { |
| inOneGroup | BIT STRING (SIZE (8)), |
| groupPresence | BIT STRING (SIZE (8)) |

}

It indicates the time domain positions of the transmitted SS-blocks in a half frame with SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted.

Quasi-Co-Location (QCL) to a relationship between antenna ports where channel properties inferred from one port can be reused to demodulate signals from another port.

Channel Property Inference: Two antenna ports are quasi-co-located if large-scale channel properties (e.g., delay spread, Doppler shift) of one port can be inferred from another. For example, if a synchronization signal (SSB) and a physical downlink control channel (PDCCH) are QCLed, the UE uses SSB-derived channel estimates to decode the PDCCH.

Large-Scale Parameters: These include:
>: Time-domain: Average delay, delay spread.
>: Frequency-domain: Doppler shift, Doppler spread.
>: Spatial: Spatial reception (Rx) parameters like angle of arrival67.

Four QCL Types are defined.

Type A: Doppler shift, Doppler spread, average delay, delay spread.

Type B: Doppler shift, Doppler spread.

Type C: Doppler shift, average delay.

Type D: Spatial Rx parameters (critical for beamforming)710.

QCL-Type D enables UE to align receiver beams using spatial parameters from reference signals (e.g., CSI-RS or SSB). By reusing channel estimates from QCLed ports, the UE avoids repeatedly measuring the same parameters.

If a UE detects an SSB with strong signal quality, the gNB can configure a QCL relationship between the SSB's antenna port and a CSI-RS port. The UE then uses the SSB's spatial Rx parameters (QCL-Type D) to optimize its receiver beam for the CSI-RS, improving beamformed communication.

If a UE detects an SSB with strong signal quality, the UE can uses the SSB's spatial Rx parameters (QCL-Type D) to optimize LR's receiver beam for LMO that is QCLed (quasi-collocated) with the SSB. The UE can uses the SSB's spatial Rx parameters to optimize MR's receiver beam for PMO that is QCLed with the SSB.

If a UE detects an LP-SS with strong signal quality, the UE can uses the LP-SS's spatial Rx parameters (QCL-Type D) to optimize LR's receiver beam for LMO that is QCLed with the LP-SS. The UE can uses the LR's spatial Rx parameters to optimize MR's receiver beam for PMO that is QCLed with the SSB that is QCLed with the LP-SS.

### LP Subgrouping

### LP_Subgrouping

LP subgrouping is a way to distribute the paging load and reduce false alarm.

Depending on circumstances and network policy, network may choose to apply either CN assigned LP subgrouping, UE-ID based LP subgrouping or both.

To apply only CN assigned LP subgrouping, network:
>: includes NUM_OF_LPSG_PER_PO in SIB1; and
>: does not include NUM_OF_LPSG_FOR_UEID in SIB1.

To apply only UE-ID based LP subgrouping, network:
>: includes both NUM_OF_LPSG_PER_PO and NUM_OF_LPSG_FOR_UEID; and
>: configures the parameters such that NUM_OF_LPSG_PER_PO is equal to NUM_OF_LPSG_FOR_UEID.

To apply both UE ID based LP subgrouping and CN assigned LP subgrouping simultaneously, network:
>: includes both NUM_OF_LPSG_PER_PO and NUM_OF_LPSG_FOR_UEID; and
>: configures the parameters such that NUM_OF_LPSG_PER_PO is greater than NUM_OF_LPSG_FOR_UEID.

In a cell that supports only CN assigned LP subgrouping:
>: UE that supports CN assigned LP subgrouping (UE has stored CN_assigned_LP_subgroup_ID that is received from AMF):
>>: determines lp_subgroup_id based on <CN assigned LP subgrouping>;
>>: performs <LO monitoring> based on the lp_subgroup_id; and
>>: performs <PO monitoring> in case that lp_subgroup_id is detected in LO;
>: UE that does not support CN assigned LP subgrouping (UE does not have CN_assigned_LP_subgroup_ID):
>>: performs <PO monitoring>.

In a cell that supports only UE-ID based LP subgrouping:
>: UE that supports UE-ID based LP subgrouping:
>>: determines lp_subgroup_id based on <UE-ID based LP subgrouping>;
>>: performs <LO monitoring> based on the lp_subgroup_id; and
>>: performs <PO monitoring> in case that lp_subgroup_id is detected in LO;
>: UE that does not support UE-ID based LP subgrouping:
>>: performs <PO monitoring>.

In a cell that supports both CN assigned LP subgrouping and UE-ID based LP subgrouping:
>: UE that supports CN assigned LP subgrouping (UE has stored CN_assigned_LP_subgroup_ID that is received from AMF):
>>: determines lp_subgroup_id based on <CN assigned LP subgrouping>;
>>: performs <LO monitoring> based on the lp_subgroup_id; and
>>: performs <PO monitoring> in case that lp_subgroup_id is detected in LO;
>: UE that supports UE-ID based LP subgrouping:
>>: determines lp_subgroup_id based on <UE-ID based LP subgrouping>;
>>: performs <LO monitoring> based on the lp_subgroup_id; and
>>: performs <PO monitoring> in case that lp_subgroup_id is detected in LO;
>: UE that support neither CN assigned LP subgrouping nor UE-ID based LP subgrouping:
>>: performs <PO monitoring>.

If LowPower-Config and LP subgrouping are configured, UEs monitoring the same PO can be divided into one or more LP subgroups. With LP subgrouping, the UE monitors the associated PO if a specific codepoint is indicated in LO corresponding to its PO. LP subgrouping is configured in case that SIB1 contains lpSubgroupConfig. lpSubgroupConfig contains NUM_OF_LPSG_PER_PO and optionally NUM_OF_LPSG_FOR_UEID.

The following parameters are used for the determination of subgroup ID:
>: NUM_OF_LPSG_PER_PO: total number of subgroups for both CN assigned LP subgrouping (if any) and UE_ID based LP subgrouping (if any) in a PO, which is broadcasted in system information; and
>: NUM_OF_LPSG_FOR_UEID: number of subgroups for UE_ID based LP subgrouping in a PO, which is broadcasted in system information.

UE's LP subgroup can be either assigned by CN or formed based on UE_ID:
>: If NUM_OF_LPSG_FOR_UEID is absent in lpSubgroupConfig, the LP subgroup ID based on CN assigned LP subgrouping, if available for the UE, is used in the cell.
>: If both NUM_OF_LPSG_PER_PO and NUM_OF_LPSG_FOR_UEID are configured, and NUM_OF_LPSG_FOR_UEID has the same value as NUM_OF_LPSG_PER_PO, the LP subgroup ID determined based on UE_ID based subgrouping is used in the cell.
>: If both NUM_OF_LPSG_PER_PO and NUM_OF_LPSG_FOR_UEID are configured, and NUM_OF_LPSG_FOR_UEID<NUM_OF_LPSG_PER_PO:
>>: The LP subgroup ID based on CN assigned subgrouping, if available for the UE, is used in the cell;
>>: Otherwise (The LP subgroup ID based on CN assigned LP subgrouping is not available for the UE), the LP subgroup ID based on UE_ID based subgrouping is used in the cell.

If a UE has no CN assigned LP subgroup ID or the cell does not support CN assigned LP subgrouping, and there is no configuration for NUM_OF_LPSG_FOR_UEID, the UE monitors the associated PO according to FIG. 13.

### CN Assigned LP Subgrouping

Paging with CN assigned LP subgrouping is used in the cell which supports CN assigned LP subgrouping (NUM_OF_LPSG_FOR_UEID is absent or NUM_OF_LPSG_FOR_UEID<NUM_OF_LPSG_PER_PO). A UE supporting CN assigned LP subgrouping in RRC_IDLE or RRC_INACTIVE state can be assigned a LP subgroup ID (between 0 to 31) by AMF through NAS signalling. The UE belonging to the assigned subgroup ID monitors its associated LO which indicates LpSubgroup_ID corresponding to CN assigned LP subgroup ID.

The LP subgroup ID of the UE is determined by the formula below:

LpSubgroup_ID=CN_assigned_LP_subgroup_ID mod (NUM_OF_LPSG_PER_PO−NUM_OF_LPSG_FOR_UEID)

The formula above ensures that LP subrouping is done properly in case that network uses smaller number of subgroup ID than maximum number.

### UE_ID Based LP Subgrouping

LP-WUS with UE_ID based LP subgrouping is used in the cell which supports UE_ID based LP-WUS subgrouping (NUM_OF_LPSG_FOR_UEID is present and NUM_OF_LPSG_FOR_UEID<NUM_OF_LPSG_PER_PO or NUM_OF_LPSG_FOR_UEID=NUM_OF_LPSG_PER_PO). For UE_ID based LP-WUS subgrouping, the subgroup ID of the UE is determined by the formula below:

LpSubgroup_ID=(floor(UE_ID/(N*Ns*Np)) mod NUM_OF_LPSG_FOR_UEID)+(NUM_OF_LPSG_PER_PO−NUM_OF_LPSG_FOR_UEID),
where:
N: number of total paging frames in T, which is the DRX cycle of RRC_IDLE state
Ns: number of paging occasions for a PF
Np is the number of subgroupsNumForUEID for PEI, if configured and UE supports PEI; otherwise, Np is 1

### UE_ID: 5G-S-TMSI mod X

X is equal to:
>: 1024*32 in case that eDRX is not applied and PEI is not applied;
>: 1024*8*32 in case that eDRX is not applied and PEI is applied;
>: 4096*32 in case that eDRX is applied and PEI is not applied;
>: 4096*8*32 in case that eDRX is applied and PEI is applied;

lp-SubgroupsNumForUEID and lp-SubgroupsNumPerPO are the subgroup number for UE_ID based subgrouping for LP-WUS and the total subgroup number for LP-WUS, respectively.

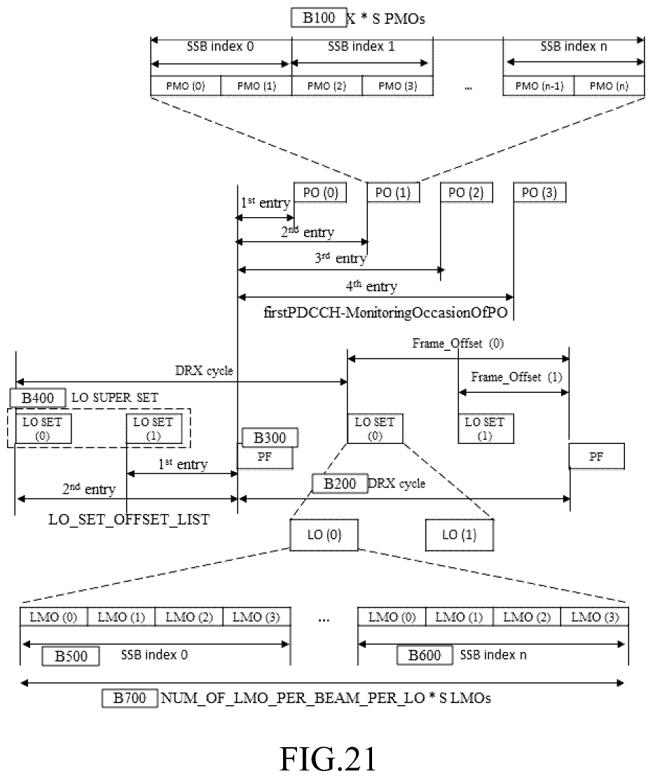

FIG. 21 Illustrates LO, LMO, PO and PMO.

### PO & PMO

A PO is set of (X*S) PMOs B100. A set of POs repeat every DRX cycle (T) B200. Number of POs per set of POs (or number of POs per T) is configured by Ns.

A UE monitors PMOs of PO associated with the UE. A PO among the set of POs is associated with the UE. PO associated with the UE is determined based on various DRX configuration parameters.

The starting time point of each PO of the set of POs is determined based on PF B300 and firstPDCCH-MonitoringOccasionOfPO.

The PO associated with the UE occurs every T.

Each PMO carries DCI for paging. When UE detects DCI for paging in a PMO of the associated PO, UE receives PDSCH according to the DCI. The PDSCH may carry a paging message.

PMOs of a PO carry DCI having same content (e.g. same PDSCH scheduling information). UEs that are associated with a PO are sub-grouped for LO monitoring. Number of lp_subgroups per PO is configured by NUM_OF_LPSG_PER_PO. NUM_OF_LPSG_PER_PO contains ‘INTEGER (1,..,31).

### LO and LMO

A LO SUPER SET B400 repeats every DRX cycle. A LO SUPER SET consists of one or two LO SETs. The number of LO SETs per LO SUPER SET is determined by the number of entries in LO_SET_OFFSET_LIST in LP-WUS-Config. LO_SET_OFFSET_LIST (C100) consists of one or two LO_SET_OFFSETs. The n-th LO_SET_OFFSET indicates a number of radio frames between PF and RF (reference frame) of n-th LO SET. The RF of a LO SET is a reference time point for LOs of the LO SET.

LO_SET_OFFSET_LIST::=SEQUENCE (SIZE (1..maxLO-perLOSET)) OF INTEGER (0..139)

n-th entry of FIRST_LMO_OFFSET_LIST is denoted as n-th LO_SET_OFFSET.

LO_SET_OFFSET_LIST is included in LP-WUS-Config.

A LO SET consists of the specific number of LOs. The specific number is configured by NUM_OF_LO_PER_LO_SET. NUM_OF_LO_PER_LO_SET indicates either one LO per LO SET, two LOs per LO SET or four LOs per LO SET.

A FIRST_LMO_OFFSET_FOR_LO_SET is configured for each LO SET. FIRST_LMO_OFFSET_FOR_LO_SET (C110, C120) consists of a specific number of FIRST_LMO_OFFSETs. The specific number is equal to NUM_OF_LO_PER_LO_SET.

n-th entry of FIRST_LMO_OFFSET_FOR_LO_SET of a LO SET indicates distance between the first LMO of n-th LO of the LO SET and the RF of the LO SET.

FIRST_LMO_OFFSET_FOR_LO_SET ::= CHOICE {

| | sCS15KH | SEQUENCE (SIZE (1..maxLMO-perLO)) OF INTEGER |
|---|---|---|
| (0..139), | | |
| | sCS30KH | SEQUENCE (SIZE (1.. maxLMO-perLO)) OF INTEGER |
| (0..279), | | |
| | sCS60KH | SEQUENCE (SIZE (1.. maxLMO-perLO)) OF INTEGER |
| (0..559), | | |
| | sCS120KHZ | SEQUENCE (SIZE (1.. maxLMO-perLO)) OF INTEGER |

(0..1119),

...

}

n-th entry of FIRST_LMO_OFFSET_FOR_LO_SET is denoted as n-th FIRST_LMO_OFFSET, which indicates the distance between the RF and the first LMO of n-th LO. INTEGER m of SCS x indicates m symbols of SCS x.

A LO is set of NUM_OF_LMO_PER_BEAM_PER_LO*S LMOs (B700).

A specific number of consecutive LMOs form a beam-specific set of LMOs (B500 and B600). The specific number is configured by NUM_OF_LMO_PER_BEAM_PER_LO in LP-WUS-Config. Each beam-specific set of LMO is associated with an actually transmitted SSB. For example, LMOs in B500 are quasi-co-located with SSB 0. LMOs in B600 are quasi-co-located with SSB n.

A LO can be associated with one PO, two POs or four POs. The number of POs per LO is either 1, 2 or 4. The number of POs per LO is determined by DIV [NUM_OF_LO_PER_LO_SET, Ns] or CEILING [NUM_OF_LO_PER_LO_SET/Ns, 1]. The number of POs per LO is denoted as num_of_po_per_lo.

Each LO is associated with NUM_OF_LO_PER_LO_SET/Ns POs. Since each PO is associated with NUM_OF_LPSG_PER_PO lp_subgroups, each LO is associated with (NUM_OF_LPSG_PER_PO+1)*NUM_OF_LO_PER_LO_SET/Ns lp_subgroups. num_of_lpsg_per_lo=NUM_OF_LO_PER_LO_SET/Ns*(NUM_OF_LPSG_PER_PO+1).

Each LO is associated with NUM_OF_CP_PER_LO. NUM_OF_CP_PER_LO contains ‘INTEGER (2,.., maxCPperLO)’. NUM_OF_CP_PER_LO is either explicitly configured (in LP-WUS_Config) or determined based on a predefined rule (NUM_OF_CP_PER_LO =num_of_lpsg_per_lo +1).

For example, in case that:
>: S=8, X=2, Ns=4;
>: NUM_OF_LPSG_PER_PO=31;
>: NUM_OF_LO_PER_LO_SET=2;
>: NUM_OF_LMO_PER_BEAM_PER_LO=4,

Then:
>: The first LO (LO-0) is associated with the first PO (PO-0) and the second PO (PO-1);
>: The second LO (LO-1) is associated with the third PO (PO-2) and the fourth PO (PO-3);
>: A LO is set of 32 LMOs;
>: A beam-specific set of LMOs is set of 4 LMOs;
>: NUM_OF_CP_PER_LO=(NUM_OF_LPSG_PER_PO+1)*Ns/NUM_OF_LO_PER_LO_SET=(31+1)*4/2=64
>: num_of_cp_per_lmo=NUM_OF_CP_PER_LO/NUM_OF_LMO_PER_BEAM_PER_LO=64/4=16
>: num_of_lpsg_per_lmo=ceiling[(num_of_lpsg_per_lo-1)/NUM_OF_LMO_PER_BEAM_PER_LO,1]=ceiling(63/4, 1)=16

### CP-Index

Each LMO of LO is associated with num_of_cp_per_lmo code points.

Each LMO carries a LP-WUS. A LP-WUS indicates a single code point out of the num_of_cp_per_lmo code points. Each code point corresponds to a specific sequence with a specific length. The specific length is correlated with on num_of_cp_per_lmo. Each code point is associated with a lp_subgroup_id of a PO.

### CP-Indexing

Each code-point in all code-points of a set of beam-specific LMOs (NUM_OF_LMO_PER_BEAM_PER_LO consecutive LMOs for a specific beam) is associated with a single cp_index.

cp_index starts from 0 to num_of_cp_per_lo-1. There are two different ways of indexing. LMO_first_CP_second approach and CP_first_LMO_second approach. In LMO_first_CP_second approach, cp_index is assigned such that cp_index increases with LMO-index first and codepoint next. In CP_first_LMO_next approach, cp_index is assigned such that cp_index increases with CP first and LMO next.

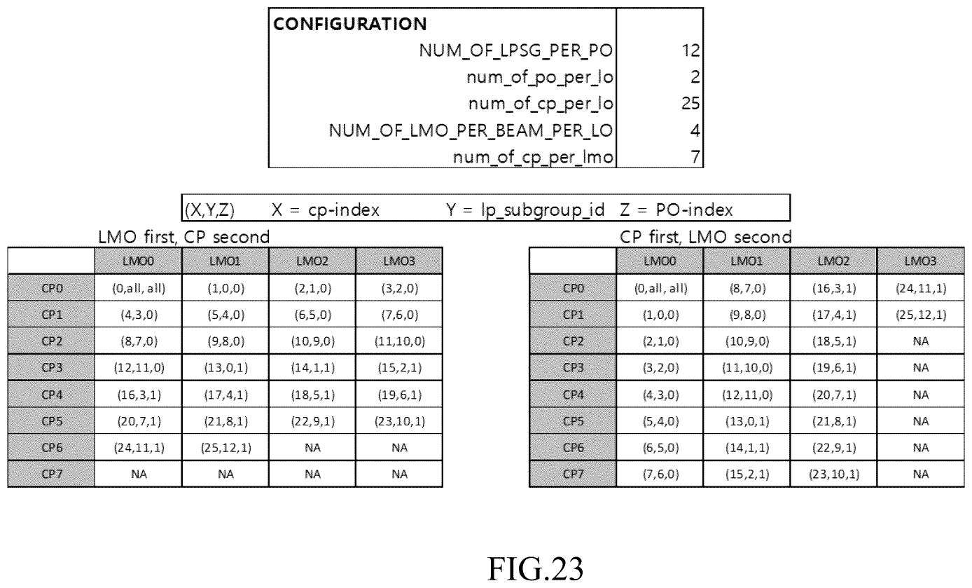

FIG. 23 illustrates an example.

In LMO_First_CP_Second approach:
>: cp-index (0)~cp-index (NUM_OF_LMO_PER_BEAM_PER_LO-1) are associated with code-point (0) of LMOs in ascending order of their LMO indexes;
>: cp-index (NUM_OF_LMO_PER_BEAM_PER_LO)~cp-index (2*NUM_OF_LMO_PER_BEAM_PER_LO-1) are associated with code-point (1) of LMOs in ascending order of their LMO indexes; and
>: so on.

In CP_First_LMO_Second approach:
>: cp-index (0)~cp-index (num_of_lpsg_per_lmo-1) are associated with code-points of first LMO (LMO 0) in ascending order;
>: cp-index (2*num_of_cp_per_lmo-1)~cp-index (num_of_cp_per_lmo-1) are associated with code-points of second LMO (LMO 1) in ascending order; and
>: so on.
   Association Between CP-Index and lp_subgroup_id/PO-index Pair

A special CP-index is associated with all LP subgroups of all concerned POs. Concerned POs denote POs that are associated with the LO.

Each of the non-special CP-indexes is associated with a LP subgroup of a PO.

The association is as below:
>: cp-index (0) is associated with all lp_subgroup_ids of all POs associated with the LO (or LMO). If code-point 0 is detected in LMO 0, all UEs that monitor the LO is required to perform <PO mointoring>;
>: cp-index (1+(1−1)*num_of_lpsg_per_lmo) is associated with the lowest lp_subgroup_id of the PO with lowest PO-index;
>: cp-index (2+(1−1)*num_of_lpsg_per_lmo) is associated with the 2^{nd} lowest lp_subgroup_id of the PO with lowest PO-index;
>: cp-index (NUM_OF_LPSG_PER_PO+(1−1)*num_of_lpsg_per_lmo) is associated with highest lp_subgroup_id (=NUM_OF_LPSG_PER_PO−1) of the PO with lowest PO-index;
>: cp-index (1+(2−1)*num_of_lpsg_per_lmo) is associated with the lowest lp_subgroup_id of the PO with 2^{nd} lowest PO-index;
>: cp-index (2+(2−1)*num_of_lpsg_per_lmo) is associated with the 2^{nd} lowest lp_subgroup_id of the PO with 2^{nd} lowest PO-index;
>: cp-index (NUM_OF_LPSG_PER_PO+(2−1)*num_of_lpsg_per_lmo) is associated with highest lp_subgroup_id (=NUM_OF_LPSG_PER_PO−1) of the PO with 2^{nd} lowest PO-index;
>: cp-index (a+(b−1)*num_of_lpsg_per_lmo−1) is associated with a-th lowest lp_subgroup_id of the concerned PO with b-th lowest PO-index.

### UE Operation

i_lo Determination

UE determines i_lo (index of associated LO) based on i_s and num_of_po_per_lo.
>: i_lo =floor (i_s/num_of_po_per_lo,1) or DIV [(i_s+1), num_of_po_per_lo].
>: i_lo is LO index of LO associated with the UE.
>: for example, when num_of_po_per_lo is 2:
>>: i_s 0 and i_s 1 correspond to i_lo 0; and
>>: i_s 2 and i_s 3 correspond to i_lo 1.

### LO SET Selection

UE selects a LO SET of a LO SUPERSET based on:
>: Time-domain-distance-value;
>: LO_SET_OFFSET_LIST; and
>: specific entry of FIRST_LMO_OFFSET_FOR_LO_SET.

UE determines specific LOs (or UE determines LO-index of the specific LOs). The specific LO is LO associated with a specific PO. The specific PO is PO which the UE is associated with. UE monitors the specific PO when UE is operating in MR mode.

UE determines specific LOs based on i_lo.

UE determines specific time points of LO SETs based on i_lo, LO_SET_OFFSET_LIST and FIRST_LMO_OFFSET_FOR_LO_SET. The specific time point of a LO SET is a reference time point for UE to determine whether the LO SET is suitable for the UE.

Specific time point is determined as below. if:
>: UE is associated with PO-index 3 (i_s=3);
>: PO-index 3 is associated with LO-index 1 (i_lo=1);
>: LO SUPER SET consists of two LO SETs;
>: Each LO SET consists of two LOs (LO-index 0 and LO-index 1);
>: UE determines the specific time point of the first LO SET (C130);
>>: the specific time point of the first LO SET is a−b+c+d;
>>>: a is the starting time point of PF (or start of associated PO);
>>>: b is normalized time distance corresponding to frame level offset indicated by the first entry of LO_SET_OFFSET_LIST;
>>>: d is normalized time length of the LO. It is derived from num_of_lmo_per_lo*LMO_LENGTH;
>>>: c is normalized time distance corresponding to slot-level/symbol-level offset indicated by the second entry of FIRST_LMO_OFFSET_FOR_LO_SET of the first LO SET;
>>: the specific time point of the second LO SET is a−b′+c′+d;
>>>: b′ is normalized time distance corresponding to frame level offset indicated by the second entry of LO_SET_OFFSET_LIST;
>>>: c′ is normalized time distance corresponding to slot-level/symbol-level offset indicated by the second entry of FIRST_LMO_OFFSET_FOR_LO_SET of the second LO SET.

UE selects a LO SET of which the gap between the specific time point of the LO SET and the starting time point of PF (or starting time point of the specific/associated PO) is no less than Time-domain-distance-value. If there are more than one such LO SETs, UE selects the closest/latest LO SET (e.g. LO SET which is closest to PF/PO).

The specific time point of a LO SET is end of the specific LO of the LO SET. In the example above, the specific time point of the first LO SET is end of LO (1) of the first LO SET. The specific time point of the second LO SET is end of LO (1) of the second LO SET.

i_lmo Determination

UE determines one or two i_lmo (index of LMO to be monitored); one associated with special cp-index; and the other associated with UE-specific cp-index.

i_lmo 0 is associated with special cp-index in case that special cp-index is lowest cp-index.

i_lmo n is associated with special cp-index in case that special cp-index is highest cp-index. N is highest LO-index.

i_lmo associated with UE-specific cp-index is determined based on i_s and lp_subgroup_id and the mapping table (T100 or T200).
>: For example, if UE's lp_subgroup_id is 4 and i_s is 1, then UE-specific CP-index is 17.
>>: CP-index 17 is associated with LMO 1. (i_lmo=1) in case that LMO_first_CP_second is applied.
>>: CP-index 17 is associated with LMO 2. (i_lmo=2) in case that CP_first_LMO_second is applied.

If same LO is associated with both special cp-index and UE-specific cp-index, UE monitors only a single LMO.

### LO Monitoring

UE monitors, to detect specific set of code-points, specific set of LMOs of the specific LO of the selected LO SET.
>: The specific LO is determined based on <i_lo determination>;
>: The specific LMO is determined based on<i_lmo determination>;
>: The LO SET is selected based on <LO_SET selection>;
>: The specific set of code points includes:
>>: lowest code-point in the first LMO (code-point for special CP-index); and
>>: a specific code-point of a specific LMO that corresponds to UE-specific CP-index.

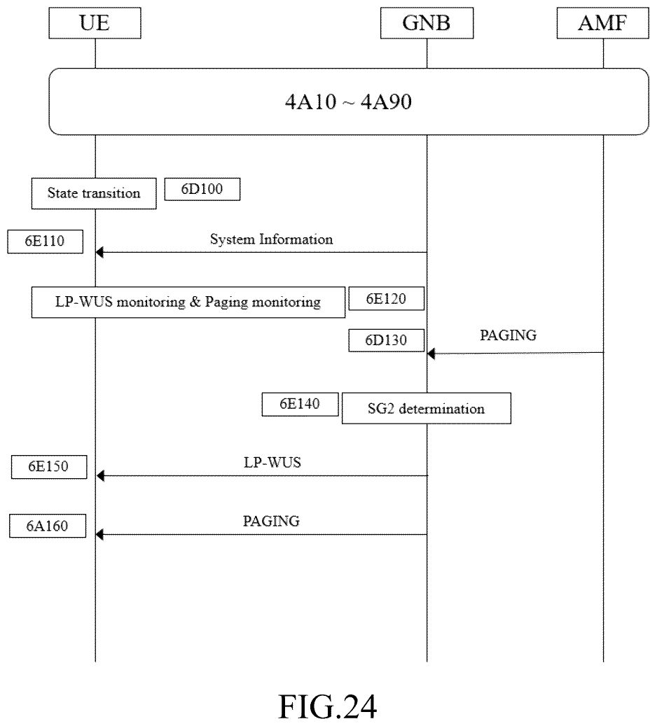

FIG. 24 illustrates operations of UE and base station.

UE, GNB and AMF perform 4A10 to 4A90.

UE performs 6D100.

At 6E110, UE receives system information.

The system information includes the following parameters in addition to the parameters in 3A31, 3B41, 3E21, 3F21, 4A110 and 6D110.

Parameters broadcast in SIB1:
>: NUM_OF_LPSG_PER_PO;
>: NUM_OF_LMO_PER_BEAM_PER_LO;
>: LO_SET_OFFSET_LIST;
>: FIRST_LMO_OFFSET_LO_SET_LIST;
>: NUM_OF_CP_PER_LO
>: LENGTH_LMO
>>: This parameter indicates the length of LMOs in number of specific symbols. The specific symbol is:
>>>: downlink symbol that is not SSB symbol (symbol that carries either SSS, PSS or PBCH); and
>>>: flexible symbol that is not overlapped with PRACH symbol.

At 6E120, UE performs LP-WUS monitoring and paging monitoring.

In addition to the operations in 6D120. UE performs the following in addition.
>: UE determines various values that are essential for

### PO_MONITORING_OPERATION_SET

>>: Ns, T, UE_ID, N, PF_offset, UE_ID_H, H-SFN, PH, PTW_start, PTW_end, L
>: UE performs <LO_MONITORING_OPERATION_SET>in case that:
>>: all conditions of MR-to-LR-switching-condition-set are fulfilled
>: UE performs <PO_MONITORING_OPERATION_SET>in case that:
>>: at least one of LR-to-MR-switching-condition set is fulfilled.

### LO_MONITORING_OPERATION_SET

UE performs the following:
<i_lo determination>;
<LO SET selection>;
<i_lmo determination>; and
<LO monitoring>.

### PO_MONITORING_OPERATION_SET

UE performs the operations specified based on FIG. 13. UE monitors one or more PMOs of a specific PO. The specific PO is indicated by i_s.

At 6E140, based on PAGING message, GNB performs followings:
>: GNB determines PO of the UE based on Paging DRX IE;
>: GNB determines LO of the UE based on time-domain-distance-value and other parameters; and
>: GNB determines lp_subgroup_id of the UE. GNB determines UE-specific LMO. GNB includes cp-index corresponding to the lp_subgroup_id in the LP-WUS. GNB transmits the LP-WUS in the LMO that is associated with the lp_subgroup_id.

At 6E150, based on determination, GNB transmits LP-WUS in LMOs of the determined LO.

Within a LMO, GNB transmits LP-WUS containing same sequence (same CP-index) in all LMOs with the same LMO-index.

If more than two LPSGs are to be paged, GNB tranmsits LP-WUS containing the sequence corresponding to the special CP-index.

When UE detects the special CP-index or its UE-specific CP-index in LP-WUS, UE switches from LR-mode to MO-mode.

UE monitors one or more PMOs of PO based on QCL assumption that PMO with beam index n is QCLed with LMO with beam index n.

### LMO Beam and PMO Beam Mapping

(NUM_OF_PO_PER_LO*X*S) PMOs are mapped to (NUM_OF_LMO_PER_BEAM_PER_LO*S) LMOs.
>: For example (E100), X*S PMOs of PO (0) and X*S PMOs of PO (1) are mapped with NUM_OF_LMO_PER_BEAM_PER_LO*S LMOs of LO (0).

For each beam, (NUM_OF_PO_PER_LO*X) PMOs are mapped to NUM_OF_LMO_PER_BEAM_PER_LO LMOs.

A set of LMOs are mapped with a specific SSB. A set of PMOs are mapped with a specific SSB. If UE detected LP-WUS in a LMO associated with a SSB x, UE may monitor PMO associated with the SSB x.

UE may apply the QCL relationship learned from LR to reception operation of MR. UE may apply the QCL relationship learned from MR to reception operation of MR.

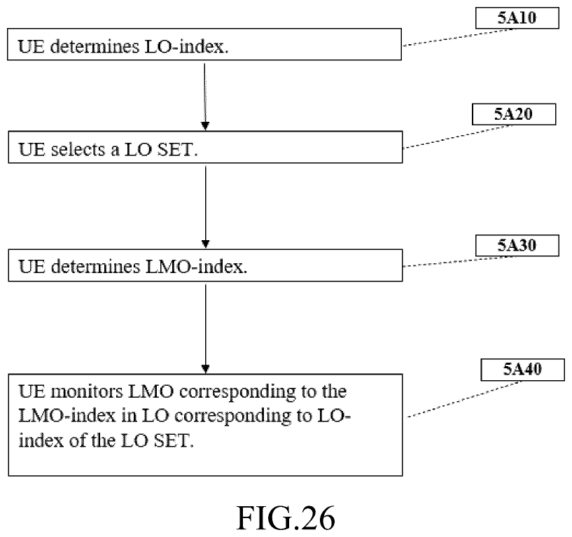

FIG. 26 illustrates UE operations for monitoring LO.

At 5A10, UE determines LO-index.

At 5A20, UE selects a LO SET.

At 5A30, UE determines LMO-index.

At 5A40, UE monitors LMO corresponding to the LMO-index in LO corresponding to LO-index of the LO SET.

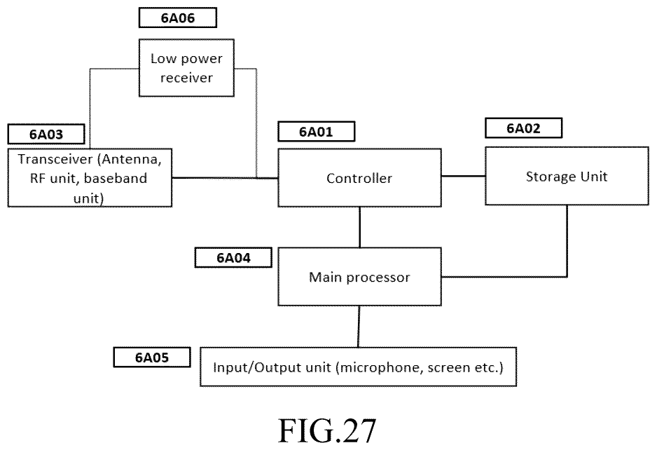

FIG. 27 is a block diagram illustrating the internal structure of a UE to which the disclosure is applied.

Referring to the diagram, the UE includes a controller 6A01, a storage unit 6A02, a transceiver 6A03, a main processor 6A04, I/O unit 6A05 and low power receiver 6A06.

The controller 6A01 controls the overall operations of the UE in terms of mobile communication. For example, the controller 6A01 receives/transmits signals through the transceiver 6A03 and through the low power receiver. In addition, the controller 6A01 records and reads data in the storage unit 6A02. To this end, the controller 6A01 includes at least one processor. For example, the controller 6A01 may include a communication processor (CP) that performs control for communication and an application processor (AP) that controls the upper layer, such as an application program. The controller controls storage unit and transceiver such that UE operations illustrated in the present disclosure are performed.

The storage unit 6A02 stores data for operation of the UE, such as a basic program, an application program, and configuration information. The storage unit 6A02 provides stored data at a request of the controller 6A01.

The transceiver 6A03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 6A04 controls the overall operations other than mobile operation. The main processor 6A04 process user input received from I/O unit 6A05, stores data in the storage unit 6A02, controls the controller 6A01 for required mobile communication operations and forward user data to I/O unit 6A05.

I/O unit 6A05 consists of equipment for inputting user data and for outputting user data such as a microphone and a screen. I/O unit 6A05 performs inputting and outputting user data based on the main processor's instruction.

Low power receiver 6A06 is connected with antenna part of the transceiver and controller. Low power receiver process LP-SS and LP-WUS based on controller's control.

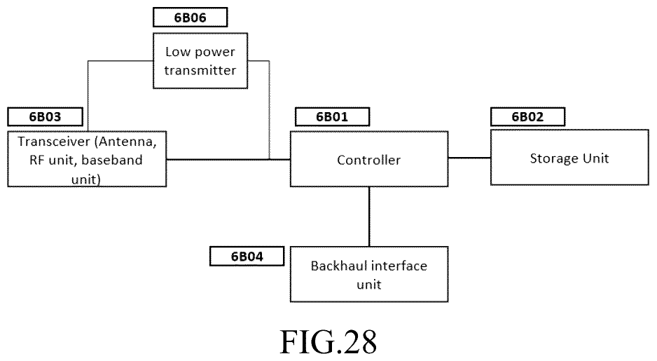

FIG. 28 is a block diagram illustrating the configuration of a base station according to the disclosure.

As illustrated in the diagram, the base station includes a controller 6B01, a storage unit 6B02, a transceiver 6B03 a backhaul interface unit 6B04 and low power transmitter 6B06.

The controller 6B01 controls the overall operations of the main base station. For example, the controller 6B01 receives/transmits signals through the transceiver 6B03 or through low power transmitter or through the backhaul interface unit 6B04. In addition, the controller 6B01 records and reads data in the storage unit 6B02. To this end, the controller 6B01 may include at least one processor. The controller controls transceiver, storage unit and backhaul interface such that base station operation illustrated in the present disclosure are performed.

The storage unit 6B02 stores data for operation of the main base station, such as a basic program, an application program, and configuration information. Particularly, the storage unit 6B02 may store information regarding a bearer allocated to an accessed UE, a measurement result reported from the accessed UE, and the like. In addition, the storage unit 6B02 may store information serving as a criterion to determine whether to provide the UE with multi-connection or to discontinue the same. In addition, the storage unit 6B02 provides stored data at a request of the controller 6B01.

The transceiver 6B03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 6B04 provides an interface for communicating with other nodes inside the network. The backhaul interface unit 6B04 converts a bit string transmitted from the base station to another node, for example, another base station or a core network, into a physical signal, and converts a physical signal received from the other node into a bit string.

Low power transmitter 6B06 is connected with antenna part of the transceiver and controller. Low power transmitter processes LP-SS and LP-WUS based on controller's control.

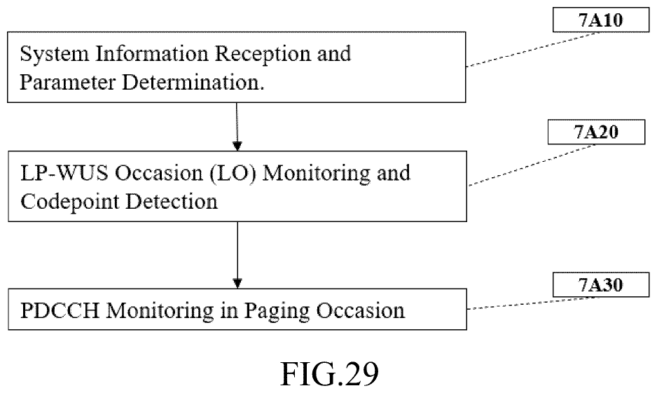

### FIG. 29 is a Diagram for UE Operations

### Step 1 (7A10): System Information Reception and Parameter Determination

The UE receives system information broadcast by the base station, which includes key parameters for LP-WUS operation such as the total subgroup number for LP-WUS (NUM_OF_LPSG_PER_PO), the number of subgroups per paging occasion, and the number of paging occasions associated with a LP-WUS occasion. Based on the received system information and the n least significant bits (LSBs) and m LSBs of its 5G-S-TMSI, the UE calculates a first occasion index to determine its associated paging occasion (PO) and a second occasion index to determine its associated LP-WUS occasion (LO). The first occasion index is derived from the number of total paging frames, the number of paging occasions, and the n LSBs of the 5G-S-TMSI. The second occasion index is derived from the number of total paging frames, the number of paging occasions associated with the LP-WUS occasion, and the n LSBs of the 5G-S-TMSI. Additionally, the UE determines its specific subgroup identifier based on the m LSBs of the 5G-S-TMSI, the total subgroup number for LP-WUS, the number of total paging frames, and the number of paging occasions.

### Step 2 (7A20): LP-WUS Occasion (LO) Monitoring and Codepoint Detection

The UE switches to a low power receiver (LR) mode and monitors the LP-WUS occasion (LO) determined in Step 1 to detect a specific codepoint transmitted by the base station. The specific codepoint is determined based on the n LSBs and m LSBs of the 5G-S-TMSI, the number of total paging frames, the total subgroup number for LP-WUS, the number of subgroups per paging occasion, and the number of paging occasions associated with the LP-WUS occasion. During LO monitoring, the UE attempts to detect either a first codepoint corresponding to its specific subgroup or a second codepoint corresponding to all subgroups. The first codepoint is UE-specific and indicates that only the UE's subgroup needs to wake up, while the second codepoint is common and indicates that all subgroups associated with the LO should wake up. If either the first codepoint or the second codepoint is successfully detected in the LO, the UE prepares to transition from LR mode to main receiver (MR) mode for subsequent PDCCH monitoring.

### Step 3 (7A30): PDCCH Monitoring in Paging Occasion (PO)

Upon detecting the specific codepoint (either the first or second codepoint) in the LP-WUS occasion (LO), the UE switches from low power receiver mode to main receiver mode and begins monitoring the physical downlink control channel (PDCCH) in the paging occasion (PO) associated with the detected LO. The PO is identified by the first occasion index calculated in Step 1, ensuring that the UE monitors the correct paging monitoring occasions (PMOs) within the PO. The UE searches for downlink control information (DCI) scrambled with a P-RNTI (Paging-Radio Network Temporary Identifier) on the PDCCH, which schedules a paging message on the physical downlink shared channel (PDSCH). If the PDCCH indicates the presence of a paging message, the UE decodes the PDSCH to receive the paging message and determines whether it is being paged by checking if its UE identity (e.g., 5G-S-TMSI) is included in the paging message. If no codepoint is detected in the LO or if the UE is not paged in the PO, the UE returns to low power mode to save battery power until the next monitoring cycle.

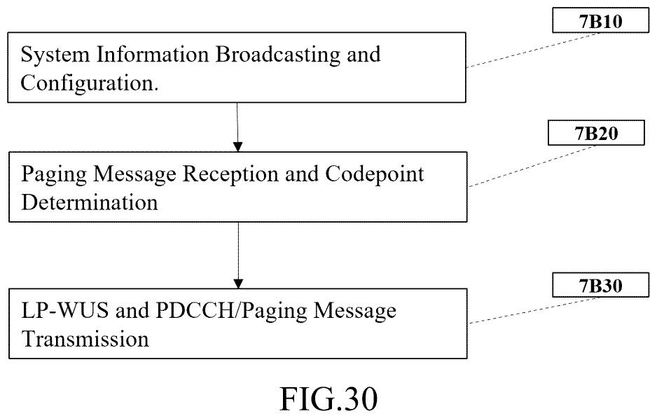

### FIG. 30 Is A Diagram for Base Station Operations

### Step 1 (7B10): System Information Broadcasting and Configuration

The base station broadcasts system information (e.g., SIB1) containing essential parameters for LP-WUS operation, including the total subgroup number for LP-WUS (NUM_OF_LPSG_PER_PO), the number of subgroups per paging occasion, the number of paging occasions associated with a LP-WUS occasion, and other LP-WUS configuration parameters. These parameters enable UEs in the cell to calculate their respective paging occasion (PO) indices and LP-WUS occasion (LO) indices based on their 5G-S-TMSI values. The base station configures the mapping between LP-WUS occasions and paging occasions, ensuring that each LO is properly associated with one or more POs according to the system design. Additionally, the base station determines the number of codepoints per LO (NUM_OF_CP_PER_LO) and establishes the association between each codepoint and specific subgroup identifiers or the common subgroup indicator. This configuration phase ensures that all UEs in the cell have the necessary information to perform efficient low-power monitoring and paging reception.

### Step 2 (7B20): Paging Message Reception and Codepoint Determination

Upon receiving a paging message from the core network (e.g., AMF) for one or more UEs, the base station extracts paging-related information including the UE identities (5G-S-TMSI values), paging DRX parameters, and optionally LP-WUS assistance information such as subgroup identifiers. Based on the n LSBs and m LSBs of each UE's 5G-S-TMSI, along with the number of total paging frames, the number of paging occasions, and the number of paging occasions associated with LP-WUS occasions, the base station determines the specific paging occasion (PO) and LP-WUS occasion (LO) for each UE to be paged. For each determined LO, the base station calculates the appropriate codepoint(s) to transmit: a first codepoint corresponding to a specific subgroup if only UEs within that subgroup need to be paged, or a second codepoint corresponding to all subgroups if multiple subgroups or all UEs monitoring that LO need to wake up. The base station also determines the specific listen monitoring occasion (LMO) within the LO where the codepoint will be transmitted, taking into account beam-specific mapping and quasi-co-location (QCL) relationships with synchronization signal blocks (SSBs). This step ensures that the correct wake-up signals are prepared for transmission to minimize false alarms and optimize power consumption.

### Step 3 (7B30): LP-WUS and PDCCH/Paging Message Transmission

The base station transmits the determined codepoint(s) in the appropriate LP-WUS occasion (LO) and associated listen monitoring occasions (LMOs) prior to the corresponding paging occasion (PO). Each codepoint is transmitted as a specific sequence in the LMO, with the sequence selection based on the subgroup identifier(s) of the UE(s) to be paged, ensuring that only the intended UEs or subgroups wake up from low power mode. After transmitting the LP-WUS, the base station prepares to transmit downlink control information (DCI) scrambled with P-RNTI on the physical downlink control channel (PDCCH) in the paging monitoring occasions (PMOs) within the determined PO. The DCI schedules the paging message on the physical downlink shared channel (PDSCH), which contains the UE identities and paging information for the UEs that detected the codepoint in the LO and switched to main receiver mode. The base station ensures that the PMOs and LMOs maintain proper quasi-co-location relationships with the same SSB beams, allowing UEs to apply the spatial information learned during LO monitoring to efficiently receive the PDCCH and paging message in the PO.

What is claimed is:

1. A method performed by a user equipment (UE) for wireless communication, the method comprising:
monitoring a low power wake-up signal (LP-WUS) occasion (LO); and
monitoring a physical downlink control channel (PDCCH) in response to detecting a first specific codepoint,
wherein the first specific codepoint is determined based on at least:
n least significant bits (LSBs) of a 5G-S-Temporary Mobile Subscriber Identity (5G-S-TMSI);
a number of total paging frames;
m LSBs of the 5G-S-TMSI;
a total subgroup number for LP-WUS; and
a number of subgroups per paging occasion (PO).

2. The method of claim 1, further comprising:
monitoring the PDCCH in response to detecting a second specific codepoint in the LO.

3. The method of claim 2, wherein:
the first specific codepoint corresponds to a specific subgroup; and
the second specific codepoint corresponds to all subgroups.

4. The method of claim 3, wherein the specific subgroup is determined based on:
m LSBs of the 5G-S-TMSI;
a total subgroup number for LP-WUS;
a number of total paging frames; and
a number of POs.

5. The method of claim 1, wherein the PDCCH is monitored in a PO.

6. The method of claim 5, wherein:
the PO is determined by a first occasion index; and
the LO is determined by a second occasion index.

7. The method of claim 6, wherein:
the first occasion index is determined based on at least:
a number of total paging frames;
a number of POs; and
n LSBs of the 5G-S-TMSI; and
the second occasion index is determined based on at least:
the number of total paging frames;
a number of POs associated with wake-up signal occasion; and
n LSBs of the 5G-S-TMSI.

8. The method of claim 1,
wherein the first specific codepoint is determined further based on a number of POs associated with wake-up signal occasion.

9. A method performed by a base station for wireless communication, the method comprising:
transmitting system information;
determining a specific codepoint for a user equipment (UE) based on at least:
n least significant bits (LSBs) of a 5G-S-Temporary Mobile Subscriber Identity (5G-S-TMSI) associated with the UE;
a number of total paging frames;
m LSBs of the 5G-S-TMSI;
a total subgroup number for low power wake-up signal (LP-WUS); and
a number of subgroups per paging occasion (PO);
transmitting the specific codepoint in a Low power wake-up signal Occasion (LO); and
transmitting a physical downlink control channel (PDCCH) in a PO associated with the LO.

10. The method of claim 9,
wherein a length of the specific codepoint is determined based on:
a number of subgroups per PO; and
a number of POs associated with the LO.
